(19) United States
(12) Patent Application Publication
(10) Pub. No.: US 2012/0143807 A1
(43) Pub. Date: Jun. 7, 2012

(54) Facts Screening and Transforming Processor

(76) Inventor: Sigram Schindler, Berlin (DE)

(21) Appl. No.: 12/756,254

(22) Filed: Apr. 8, 2010

Related U.S. Application Data
(60) Provisional application No. 61/168,036, filed on Apr. 9, 2009.
(60) Provisional application No. 61/169,159, filed on Apr. 14, 2009.
(60) Provisional application No. 61/170,217, filed on Apr. 17, 2009.
(60) Provisional application No. 61/181,998, filed on May 28, 2009.
(60) Provisional application No. 61/183,279, filed on Jun. 2, 2009.
(60) Provisional application No. 61/184,938, filed on Jun. 8, 2009.
(60) Provisional application No. 61/219,209, filed on Jun. 22, 2009.
(60) Provisional application No. 61/223,127, filed on Jul. 6, 2009.
(60) Provisional application No. 61/227,565, filed on Jul. 22, 2009.
(60) Provisional application No. 61/234,376, filed on Aug. 17, 2009.
(60) Provisional application No. 61/236,366, filed on Aug. 24, 2009.
(60) Provisional application No. 61/240,401, filed on Sep. 8, 2009.
(60) Provisional application No. 61/252,894, filed on Oct. 19, 2009.
(60) Provisional application No. 61/255,372, filed on Oct. 27, 2009.
(60) Provisional application No. 61/259,930, filed on Nov. 10, 2009.
(60) Provisional application No. 61/261,585, filed on Nov. 16, 2009.
(60) Provisional application No. 61/263,679, filed on Nov. 23, 2009.
(60) Provisional application No. 61/296,089, filed on Jan. 19, 2010.
(60) Provisional application No. 61/304,549, filed on Feb. 15, 2010.
(60) Provisional application No. 61/313,860, filed on Mar. 15, 2010.
(60) Provisional application No. 61/319,088, filed on Mar. 30, 2010.

(51) Int. Cl. G06N 5/02

(52) U.S. Cl. 706/46

(57) ABSTRACT

Be TT.p the “technique teaching” of a patent or venture and RS a “reference set” of prior art technique teachings TT.i, any element of any TT described by attributes. Then the FSTP (semi)automatically determines their “technical secondary structured fact, <q, AS)>”,
q≧0 being the minimal number for which exists “q conceptual modifications, q-cM” and a “q-anticipation-combination, q-AC” of TT.i attributes, with “q-AC/mod(q-cM) achieves TT.p”,
AS being the “achievement set” of all pairs <q-AC, set of all q-cMs for it>.
   q indicates TT.p as trivial/obvious over RS iff q=0, otherwise as nontrivial/nonobvious—whereby
q>0 is the “semantic/creative height of TT.p over RS”, thus quantifying its “indicative power”,
AS showing all shortest ways of finding TT.p starting from RS.

The FSTP then,
i) determines the minimal “creativity fact” of a venture's result—e.g. of a TT.p—starting from prior knowledge and
ii) manages this fact regarding its contexts by an ontology based expert system (e.g. for the patent area such context-ontologies are national legal patent systems and their precedents, subject areas of patentable innovations, administrating a TT.p's prior_art and pertinent_skill, prosecution, continuation, implementation, testing, infringing/licensing/contracting/marketing, litigation, . . . ).

### I. THE FSTP EXPERT SYSTEM AND ITS CONTEXTS

Supporting designing patents for done inventions is the main issue in e.g. US 2002/0059076, US 2003/0065637, US 2004/016 8129, US 2008/0148143, US 2008/0178114. Efforts of evaluating such inventions scientifically exist since long time. Why they all are legally only remote to the Facts Screening and Transforming Processor (FSTP) is explained in Sections I.E-I.G.

By contrast, the FSTP analyzes a still developing or already done invention and all relevant contexts, e.g. taking into account the national patent systems and their Highest Courts' precedents, for facts indicating—i.e.: not judging on—its novelty/nontriviality/patentability/nonobviousness/nonequivalence/creativity. I.e., using some appropriately described contexts, the FSTP may screen them, this invention and its prior art for relevant facts and transform them into a novel technical secondary “structured fact” of this invention, which indicates its such properties (see Sections I.A/I.B) and its manifold interrelations to these contexts, whereby this novel fact consists of
the minimal value q of “conceptual modifications, q-cM” to the prior art needed for making it comprise this invention, indicating it as trivial/obvious or nontrivial/nonobvious over prior art iff q=0 resp. q>0, and
the “q-cM-set(s)” alias “q-cM-structure(s)” alias “TT.p achievement structure(s)” justifying this value, whereby the value of q quantifies the “indicative power” of this technical secondary structured fact.

### BRIEF DESCRIPTION OF THE DRAWINGS

FIG. 1a outlines the overall technical structure of the FSTP;

FIGS. 1b-1c elaborate on the structure of an exemplary HW/SW embodiment;

FIGS. 2a-2d, 3a-3b, and 4a-4j illustrate subject matter ontologies and context ontologies;

FIG. 5a illustrates fundamental functions to be executed during performing an FSTP analysis;

FIG. 5b elaborates on the structures of the sequences of steps of the executions of FIG. 5a.

In the sequel the terms “patent”/“venture” and its “invention”/“TT.p”/“result” are used as synonyms. The FSTP's functionalities disclosed subsequently require software controlled hardware embodiments (see Section I.J).

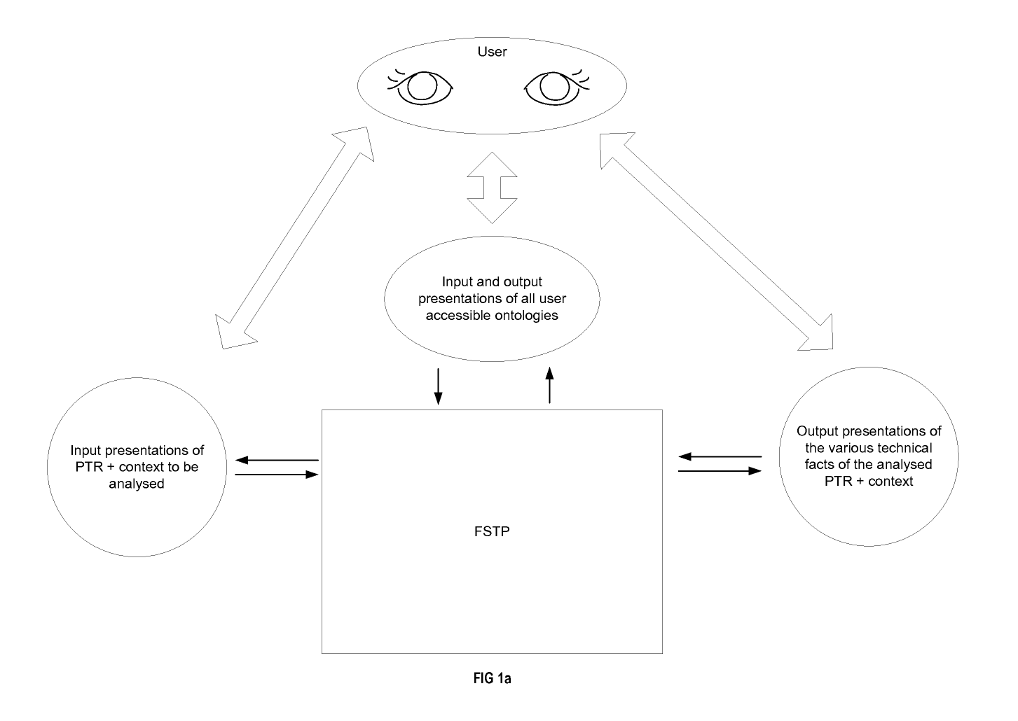

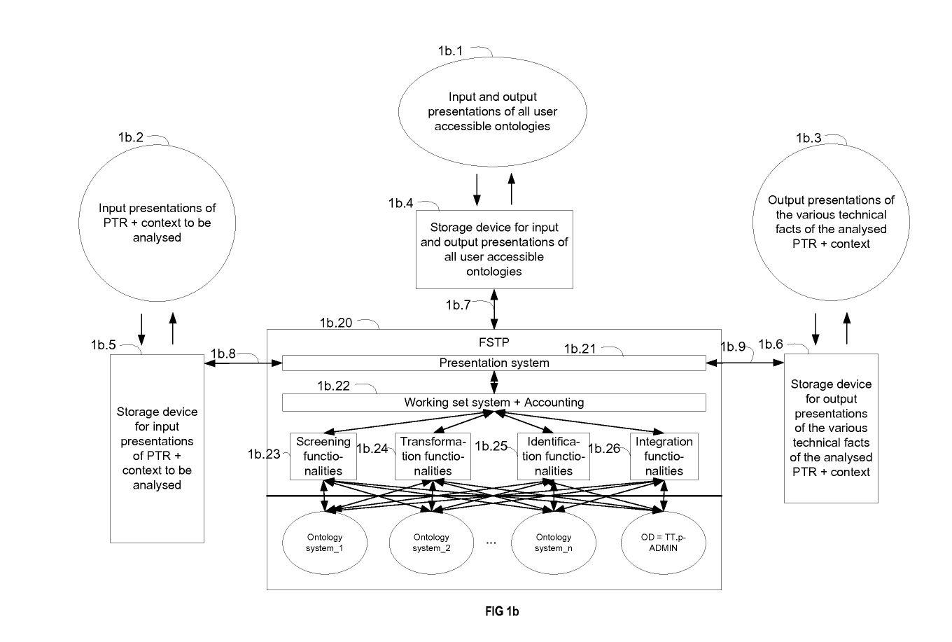

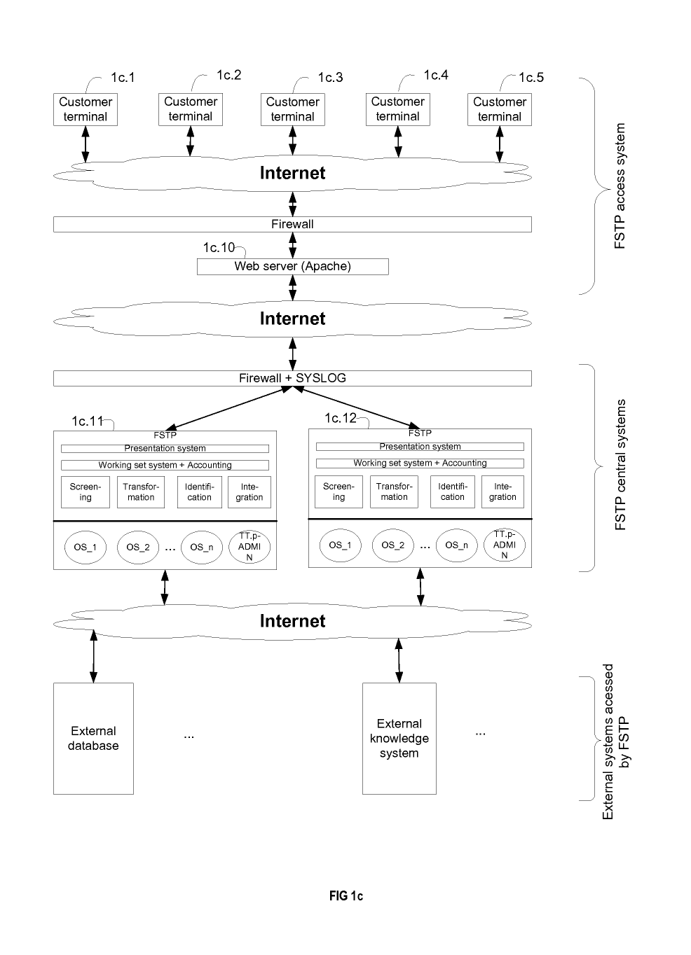

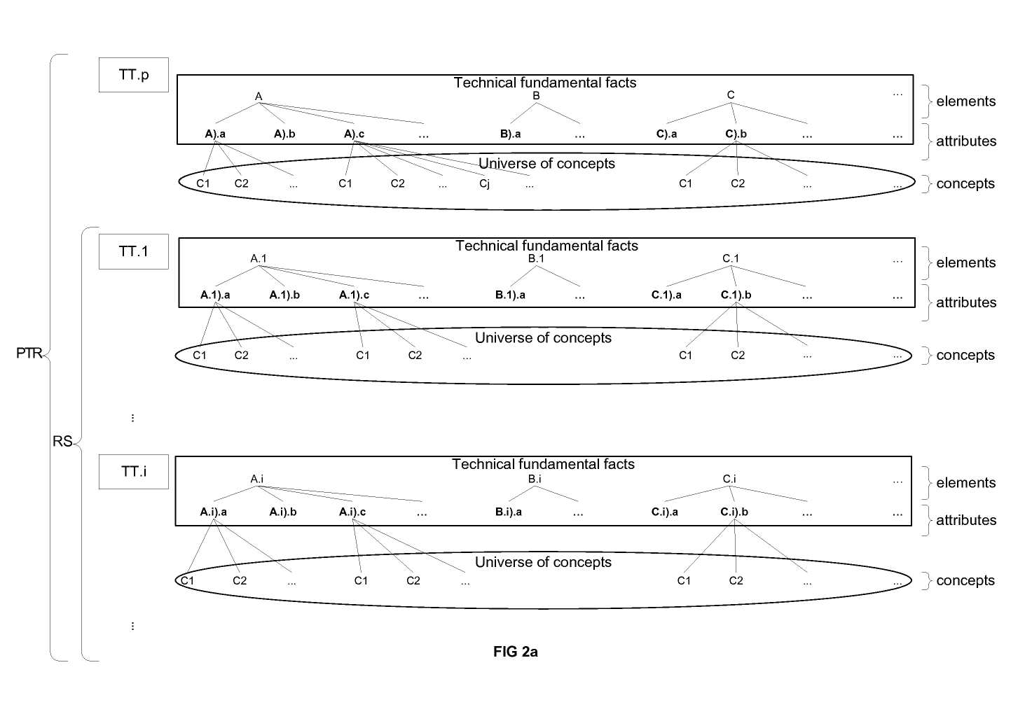

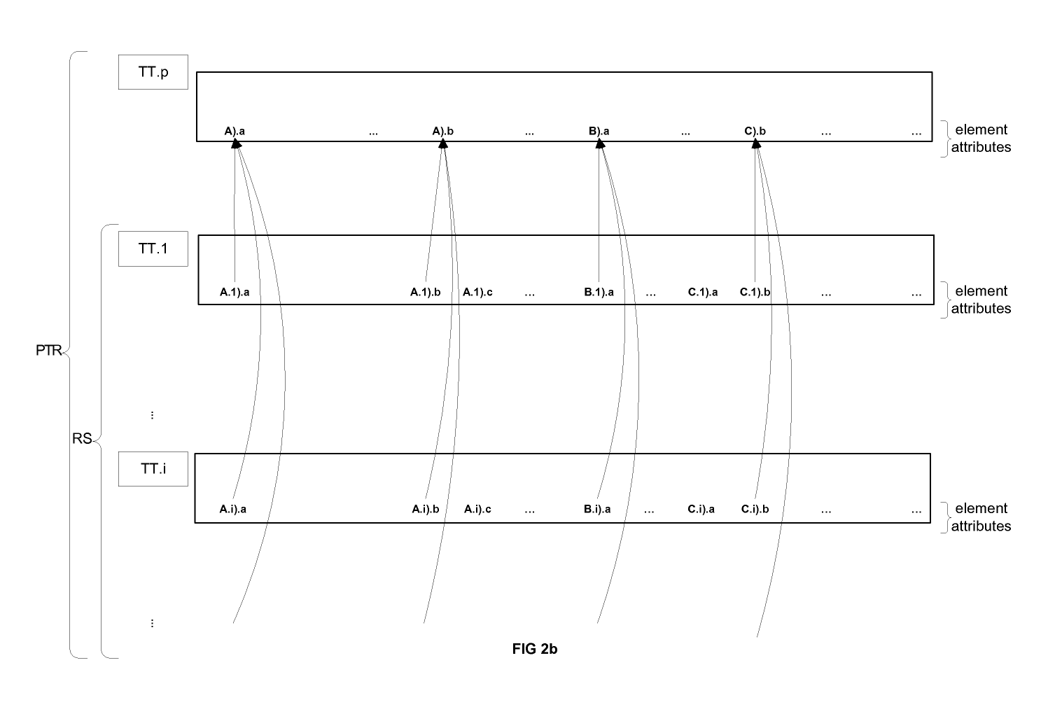

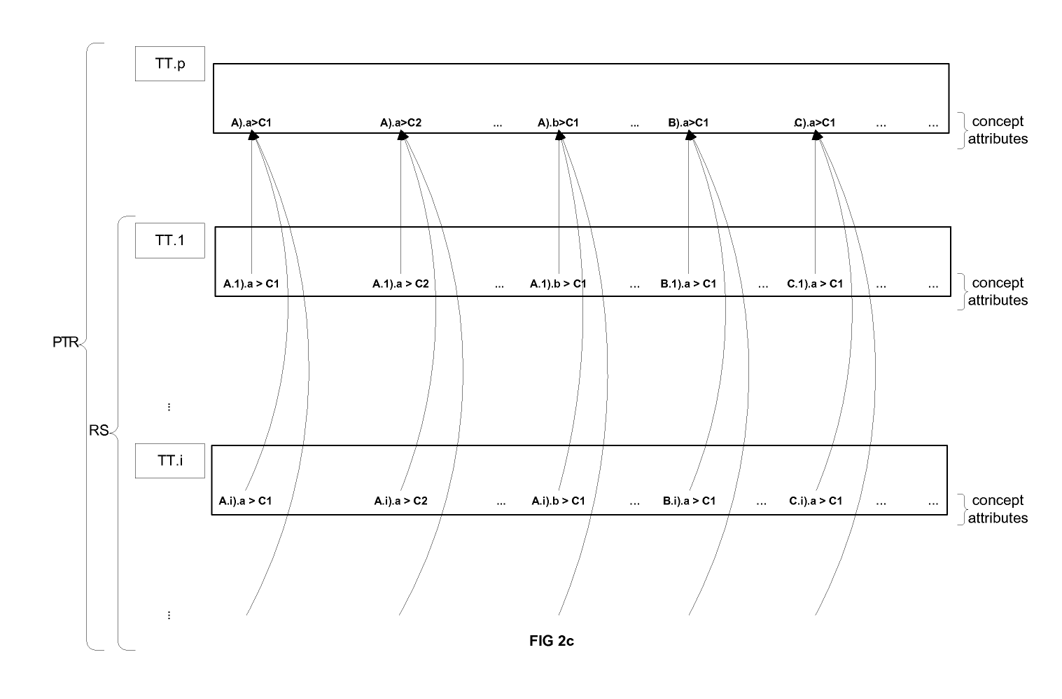

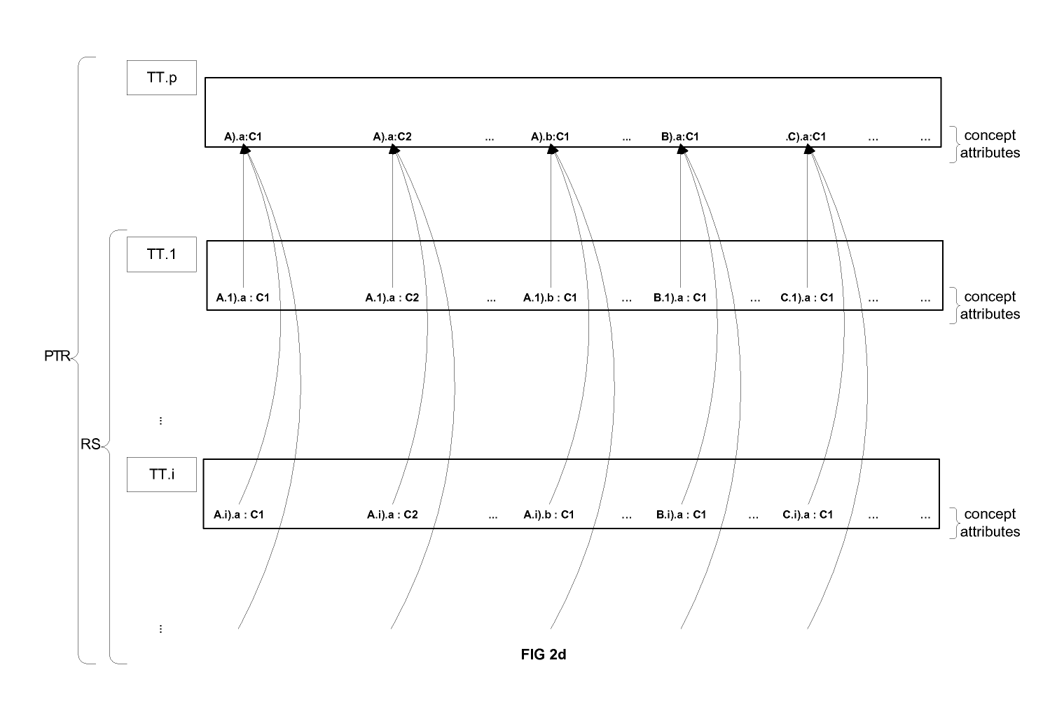

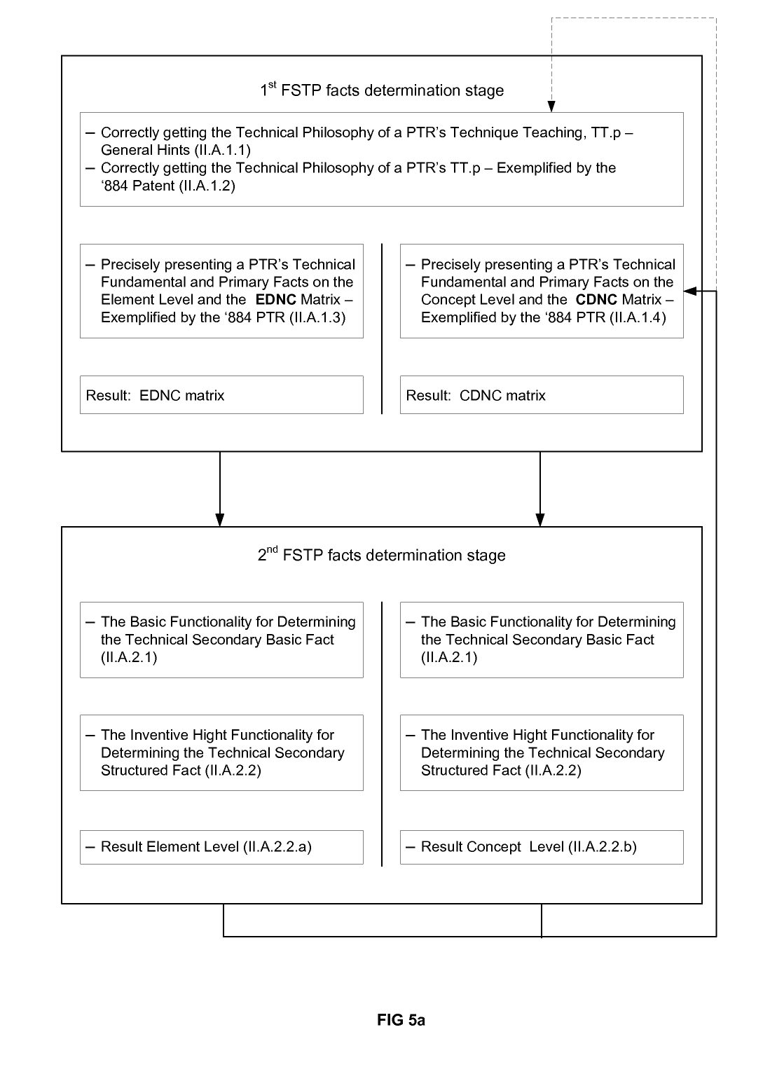

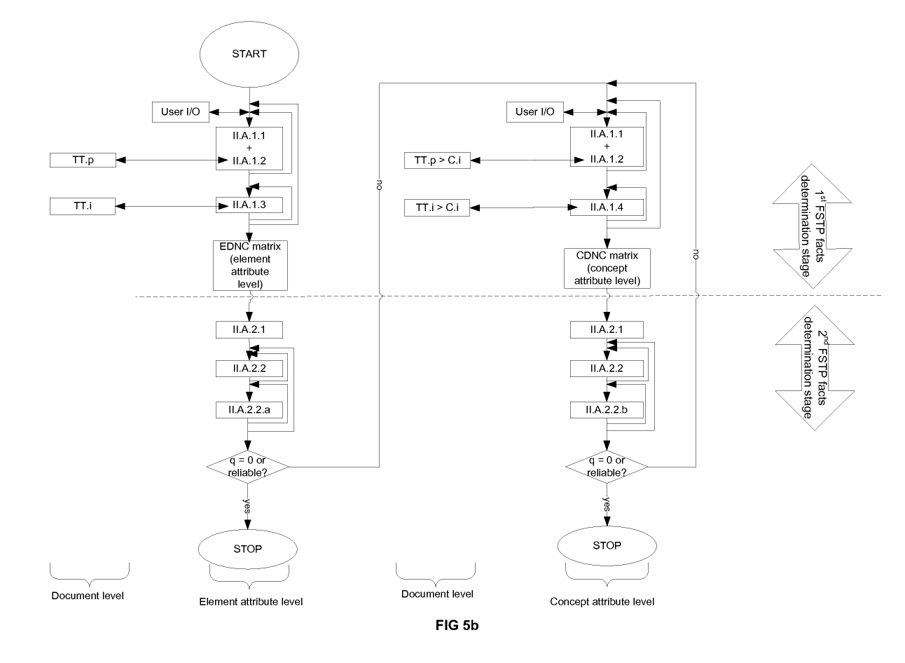

The FIG. 1a outlines the overall technical structure of the FSTP, while the FIGS. 1b-1c elaborate on the structure of an exemplary HW/SW embodiment of these technical FSTP functions (see Sections I.G and I.H). Its user communicates with it—as frequently as and whenever needed by him or the FSTP prior to and during performing an “FSTP analysis”—via three kinds of interfaces: those shown left and right and on top of the FSTP for inputting/outputting, potentially in a variety of presentations, the ontologies to be analysed resp. the technical facts derived by it and/or to be taken into account by it in this analysis resp. the context ontologies of this analysis and or for specifying/modifying all that. An ontology denotes some (to be defined, e.g. by the user) knowledge presentation (to be defined, e.g. by the user) about some whatsoever being (to be defined, e.g. by the user), here: an invention and its prior art to be analysed and provided in some natural language presentation, and/or the former's ontology of various kinds of contextual knowledge presentations, as explained below—whereby an ontology always belongs to a named “ontology domain, OD”, in the following figures expressed by the headline “OD=name of ontology domain” in an ellipse or a more unusual curve representing it. The FSTP presents its intermediary as well as final outcomes of its analysis—of its two main kinds of ontologies (subject matter ontologies and context ontologies, explained in FIGS. 2-4) input to it—through the right interface. The fundamental functions to be executed during performing an FSTP analysis are identified by FIG. 5a, while FIG. 5b elaborates on the structures of the sequences of steps of these executions (see Sections II and III).

Leaving aside the contexts for a moment, the FSTP needs a formal logic description of the invented technique teaching (“TT.p”) and of the prior art technique teachings (“TT.i's”), which denotes by

A, B, C, D, . . . elements of the TT.p,

A.i, B.i, C.i, D.i, . . . elements of the TT.i's being the peers (to the TT.p's elements) in document.i, i=1, 2, 3, . . . , and

X).n, X.i).n the peer attributes of these elements X and X.i (=A/A.i, B/B.i, C/C.i, . . . ), n=a,b,c, . . . ,

whereby any document is assumed to disclose only one TT (see footnote 11). The formal attributes of a TT's elements are the precise specifications of all here relevant properties of this TT (and hence of any of its embodiments).

While the term “technique teaching”, TT, of a patent (application) is well-known in any patent system as basically being the functional description of the solution of the patent's problem to be solved, it here is used to denote also the functional description of the result of any kind of venture solving a defined business problem, i.e. independently of whether this problem and its solution (alias TT.p) is described in a patent or some other document.

Let us denote by the terms:
“reference set, RS” this set of TT.i's and/or the set of document i's representing the prior art for this TT.p,
“technical fundamental facts” an informal or formal logic description of this “pair <TT.p, RS>”, called “PTR”,
“technical primary facts” the “discloses/not-discloses-and-not-contradicts/contradicts relation, DNC” between these attributes X.i).n's and X).n's (the flexibility in defining the X).n's and X.i).n's is not elaborated on in this patent application), which are similar to the classic “Graham technical facts” (being described without formal attributes, thus being imprecise and not-automatically processable, and therefore irrelevant here)—or between a “conceptualized refinement of the X.i).n's and X).n's” (see Section II.A.2.2)—and finally
“technical secondary “basic” or “structured” facts”—which are one of the three “centres of gravity” of this document, outlined in Sections I.A-E (while Sections I.F-K describe its two other “centres of gravity”)—whereby for a PTR its
   technical secondary basic fact is frequently called “classical/conventional”, as it is known since long time—though its notion is elaborated on, here, making it more disclosive—and
   technical secondary structured fact, often called “novel” as unknown prior to this document, consists of a pair the two components of which are the
   1.) “semantic height, q”¹⁵⁾ of its TT.p over the state of the art represented by its RS (q=0, 1, 2, . . . , see¹³⁾), indicating the degree of nonobviousness of TT.p over RS—the measurement unit being “independent thought”—as q of them are needed at least for getting at TT.p starting from RS, i.e. q is the minimal number of “conceptual modifications, cM” of any combination of attributes from RS making at least one so modified combination be an “actual anticipation-combination”¹³⁾ of the TT.p, and the ¹⁵ Synonyms to this technical expression “semantic height” alias “inventive height” alias “creative height”—the adjective “semantic” refers to the height of the TT.p over the RS, not to the TT.p as such, see¹³⁾—would be: The “size of the inventive step” or “amount of inventive activity” or “amount of creativity” required in order to get from prior art to a TT.p (being the invention), or the “inventive distance” or the “semantic height/distance” of a TT.p above/from the prior art, as represented by some RS, or . . . .¹³ For a PTR, the notion of an “anticipation-combination” of its TT.p over its RS is used already in the beginning of Section I. It is defined to be any set alias combination of X.i).n's of RS, which allegedly already “achieves” its TT.p, i.e. discloses it or is supposed to eventually achieve/disclose it (i.e. after applying one or several cMs to these X.i).n's). An anticipation-combination's TT.ac relates to the TT.p as described in the end of Section I.B. This gives rise to qualifying an anticipation-combination as a. being actually achieving TT.p, i.e. being an “actual anticipation-combination”, or not—whereby the former holds if its TT.ac discloses TT.p (see the end of Section I.B)—and/or b. “contradicting” or “not-contradicting” TT.p—see the end of Section I.B for its contradiction of the TT.p, and for an “inner contradiction” within document.i generated by a cM of one or several of its X.i).n's, see the 2^{nd} bullet point in the 3^{rd} of its 5 paragraphs—and/or c. achieving TT.p “element-wise” or “not-element-wise” (alias “element integrity preserving” ort not)—see below—or d. being free, which means that the properties b. and c. are not of concern, as well as being e. changed by one or several cM(s) or not-changed (i.e. left as its X.i).n's are disclosed in their resp. up to 15 document.i), f. whereby a sub-patent-law cM may be granted or not. As to b.: Perhaps too courageously extrapolating into the future some of the Highest Courts' precedents as a general rule, a document.i with a TT.i contradicting the TT.p—perhaps already one fold, but in any case many fold—should a priori be excluded from any anticipation-combination, as then its TT.i is “teaching away” from the TT.p. This is depending on national precedents. As to f.: This also is depending on national or a court's precedents or may even be case specific. As to c.: Several Highest Courts' precedents impose clear limitations by stating that an actual anticipation-combination must preserve the integrity of the combined elements, i.e. that cherry-picking disclosures/anticipations of an X's attributes X).n's by X.i).n's from different document i's is inadmissible, what here is referred to as the “element-wise” or “element-by-element” anticipation-combination limitation. Consistent to such Highest Courts precedents, the FSTP may preserve this element integrity requirement, when searching for actual anticipation-combinations. Note that, for a PTR, the set of all not-changed anticipations-combinations over its RS (perhaps with the exception of the various cMs subject to f. for any of these not-changed anticipation-combinations over its RS) may be considered as the “combinatorial potential or closure or hull of RS” alias “RS hull”—being of one of the kinds identified by b., c., or d., too—above which the semantic/creative height q of TT.p over RS is determined by the FSTP (see Section II.A.2.2.b). In the '884 case, all 16 documents.i show the need to modify at least 3 elements X, namely of A, C, and D, implying that in an element-wise anticipation-combination (which therefore does not exist here) only the '884 element B might be anticipated/disclosed by the document.i attributes B.3).a and B.6.)a. As to e.: The set of q cMs changing an X.i).n is called “q-cM”, and the result of these q changes “X.i).n/mod (q-cM)”. If an actual anticipation-combination contains a total of q such changes of its X.i).n's, it is called “q-anticipation-combination”. The prefix “actual” and “q” of this term is sometimes left out.
   2.) “inventive/creativity structure(s)”¹³⁾ being the set of all pairs, which consist each of
      .) one such q-anticipation-combination of not-changed attributes¹³⁾ (i.e. granting this minimal q), and
      :) all set(s) of q possible cMs of this combination making it an actual anticipation-combination of the TT.p—whereby any one of these sets of q cMs, called q-cM, represents a shortest path of inventing TT.p starting from RS (more precisely: from its “q-anticipation-combination” of not-changed X.i).n's), i.e. any cM in any such q-cM represents an absolutely indispensable inventive/creative step of conceptually modifying one X.i).n, i.e. the state of the art as by it hitherto unknown) on this path.

The FIGS. 2a-2d visualize the notional structures established by these terms of the above first three bullet points. I.e., they point out the structure of any knowledge presentation of the so-called “PTR ontology”, which includes its DNC matrixes (see Section II.A). The left margin in all three figures shows that a PTR ontology—PTR for short—is based on a pair <TT.p, RS>, and the right margin its always recurring “basic information”. FIG. 2a identifies by the set of horizontal rectangles the technical fundamental facts and by the set of horizontal ellipses the universe of concepts, to which they refer (see Sections I.A and I.B). FIG. 2b shows the technical primary facts of the EDNC matrix: Any arrow stands for one of the 3 relations discloses/not-discloses/contradicts between the X.i).n and the X).n it connects (as explained in Section II.A.1.3). The corresponding meaning of FIGS. 2c-2d and their visualizations of conceptualizations and their DNC matrixes becomes clear in Sections II.A.1.4 and II.A.2.2.b.

Determining, for a PTR, “by hand” the technical secondary basic fact in full is error prone, extremely tedious, and probably incomplete, i.e. senseless—and determining by hand its technical secondary structured fact is impossible. The FSTP performs this determination in both cases correctly, conveniently (i.e. semi-automatically), and completely—on a gross as well as on a fine level of resolution level of the PTR's technical fundamental facts. I.e.: For a PTR, the FSTP correctly and completely determines for both these technical secondary facts the un-questionable “degree q=0, 1, 2, 3, . . . ,∞ of its (non)triviality/(non)obviousness/(non)creativityless indication” over RS (independently of this invention's/TT.p's subject matter being technical or nontechnical, whatever this term “technical” means) and in particular also “all the shortest path(s) of inventing the TT.p starting from RS”. Therefore, for a value q>0, a PTR's technical secondary structured fact is much more indicative for its nontriviality/nonobviousness/noncreativityless than its classical technical secondary basic fact.

Thus, an invention's/TT.p's value of q≧1 is an indication of its patentability due to its “pushing back frontiers in some useful art by the distance q≧1”—if patenting inventions in this useful art is foreseen—i.e. the value of q quantifies the distance of this pushing back achieved by the TT.p.

Understanding the preceding statements about technical facts and the working of the FSTP requires understanding, first of all, the interrelations between its key terms—such as “TTs”, attributes “X).n” of the elements “X”, the disclosures of “X's” and “X).n's” in documents and of “concepts” they are referring to. The remainder of this Section I starts with outlining these interrelations, sometimes referring to notional and technical elaborations being presented only in the subsequent Sections. Although these early references cannot yet be understood in detail at first reading, their basic ideas are nevertheless easy to grasp here already, in particular those ideas provided by footnotes (usually being “self-contained”). An elaborate example of using all these terms' meanings is provided by Section II by explaining the application of the FSTP in a practical case.

Some ground laying notions—needed for explaining the FSTP's working—are provided first in Sections I.A-I.E, while Sections I.F-I.H (and most of the Figures) then explain this application's second “centre of gravity”.

I.A The term “technique teaching of a document, TT” is a synonym of the term “invented procedure as disclosed in this document”. As part of an unquestionable facts determination for a PTR's TT.p concerning its nonobviousness/nontriviality indication, two kinds of descriptions of the TTs in a PTR are indispensable, namely:
One set of TT and their respective terms descriptions in natural language is needed, which convey the TT.p's and TT.i's basic philosophies (see Section II.A.1), thus outlining distinctions—and commonalities—between the PTR's TT.p and its TT.i's, in particular between the terms used by the latters (being the basic technical facts).
The other set of TT descriptions, being refinements of the above descriptions (see Section II.A.2), meticulously describing all details of these terms' properties being relevant here, allow to precisely stating these distinctions/commonalities between them. From system design is known: Such details are conveyable only by attributes, here of the elements of the TTs. Such attributes, the technical fundamental facts, play the key role in the FSTP.

For a PTR, the attributes X).n and X.i).n (again: of the elements X and X.i of its TT.p and its TT.i's) are logical expressions consisting of logical components, which interrelate these attributes and/or their components to each other and/or to values of independent “concepts, C.j”, 0≦j≦jC. I.e.: Subsequently is assumed that different concepts are independent and that also logical components may be put as concepts. Concepts represent
“technique-intrinsic” issues—being totally physical/technical in nature—such as “points in some time” or “locations in some space” or “entities of some physical/technical kind” or . . . and/or
“logic-/application-/objectives-/user-/invention-/prior art-/ . . . -intrinsic” issues—being less or even non-physical/-technical in nature—such as “parts” or “steps” or “advantages” or “qualities” or “feelings” or “tolerances” or “invented features” or “prior art features” or . . . .

Independent C.j's are either formal language constructs of X).n and X.i).n or references to requirement areas (e.g. to “IT system design requirements e.g. related to system performance issues”, to “market acceptance requirements e.g. related to usability issues”, to “application requirements e.g. related to data loss/delay/jitter”).

The definitions of the set of C.j's for a PTR and their ranges of values (and possibly relations defined on the latters, which is assumed to be simple, such as C.j: being binary only, or having a totally static order on its values, or a partially static order on them, or no static order at all on them but a totally dynamic order on . . . ), i.e. of this PTR's universe ontology, are input to the FSTP by its user or are recognized automatically by the FSTP from the documents' disclosures. The references by the attributes X).n/X.i).n to the values of the C.j's may also be automatically derived from these attributes by the FSTP and then possibly fed back to its user for confirmation or adjustment. These C.j's represent the common finite “universe” ontology being an implication of the PTR ontology, the latter's only “OD=universe” ontology, to only the values of which all attributes X).n and X.i).n of a PTR refer. As a consequence, the attributes X).n and X.i).n (remember: to be input to the FSTP by its user or detected by it automatically from the documents' disclosures) are very simple: they namely model only all the PTR's TT's′ particularities over this universe, and this only as far as relevant for discriminating theses TTs from each other. I.e.:
The formal attributes X).n and X.i).n need not describe, how to build a machine realizing the TT.p or a TT.i, but only precisely describe the relevant distinctions/commonalities between the TT.p and the TT.i's, and
these commonalities/distinctions are condensed by the FSTP first into technical primary facts and these then into the most important technical secondary facts—as these provide clear indications of the (non)obviousness of the TT.p over these TT.i's, which then would be used by a court's judges to actually rule the TT.p as being (non)obviousness over these TT.i's.

Once more, for excluding misunderstandings about the FSTP: It determines, for a PTR, unquestionable indicators of its TT.p's (non)obviousness over its RS—but it leaves the legal judgement of these indications to the courts, i.e. it totally refrains from stating its TT.p being (non)obvious over its RS.

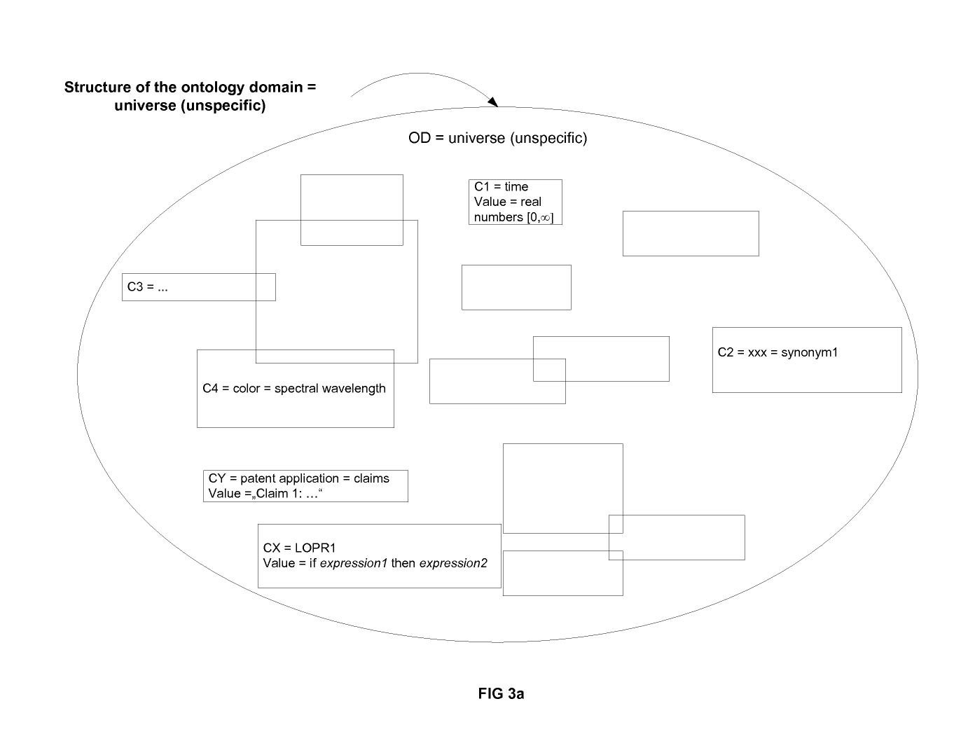

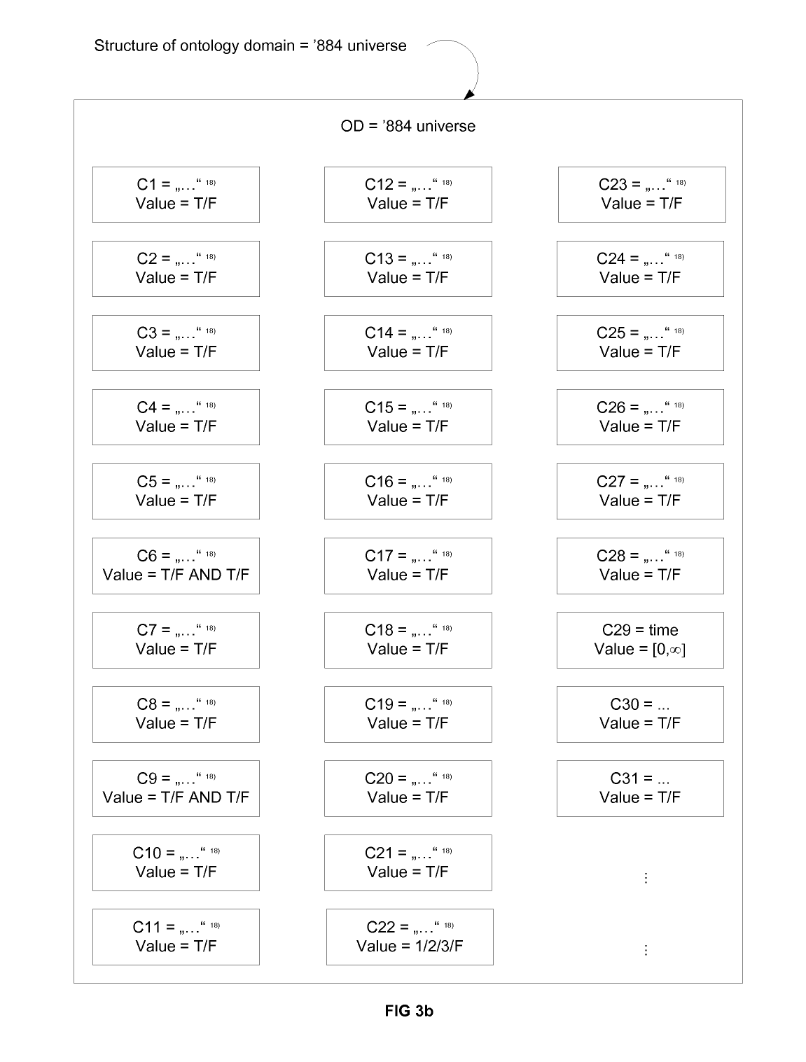

FIG. 3a outlines the general structure of a “universe ontology”, and FIG. 3b shows the structure of the specific '884 universe ontology based on footnote 18.

Let the “concept space, CS” of a PTR's universe ontology be the infinite set (e.g. due to the concept of time) of all finite sets consisting of exactly one value from its universe ontology for exactly each reference to it by exactly each of PTR's attribute X). For any attributes X) of this PTR then there is a “truth set of X), TS(X))” consisting of all elements of this PTR's CS, on which holds “X)=true”, and the same applies for any TT and for any anticipation-combination of the PTR.

I.B Having the notions introduced in Section I.A, this Section I.B can easily explain, what the above mentioned EDNC relation means in principle—i.e. without considering skill based sub-patent-law modifications and/or details with jurisdictions or courts or cases (see Section III).

The FSTP (semi)automatically derives, for this PTR:
in a first step, its technical fundamental facts X).n and X.i).n, and technical primary facts (on the two above levels of resolution), the latter being the EDNC relation between the X.i).n and the X).n,
in a second step, its technical secondary facts—consequently again on the two above levels of resolution.

The meaning of the EDNC relation between the 1^{st} and 2^{nd} component of a pair <X.i).n, X).n> is for
X.i).n not-discloses X).n defined to be as understood by the person skilled in the pertinent art—formally: TS(X.i).n) and TS(X).n) are disjoint (otherwise: X.i).n discloses X).n on any common element of CS), and for
X.i).n contradicts X).n defined to be an amplification of the “not-discloses” relation in that it exists, iff there is no way to create a “contradiction-free” expansion or change of X.i).n—i.e. of TS(X.i).n)—such that this not-discloses relation between them disappears, i.e. without generating an additional contradiction between an X′.i).n′ and its pair X′).n′ or some X″.i).n″ (the X″.i).n″ possibly to be derived only to this end by the FSTP and/or its user from the document i's disclosures, see¹³⁾).

Starting from a PTR with a finite universe of Cj's (though any Cj's value set may be infinite), 1≦j≦jC, let
one of this PTR's concepts be the commonly known “time, t”, starting at t=0 and extending to some t=t^{RP}>0, whereby t^{RP} identifies the end of the PTR's “reference period, RP”.
a “TT.ac” be defined for any 0≦t≦t^{RP} as some anticipation-combination—see¹³⁾ for the various kinds of anticipation-combinations—of this RS's X.i).n's allegedly actually achieving or at least eventually to achieve TT.p at any such value of t (for all its X.i).n's, whereby a single “sub-patent law” cM is tolerable, see¹³⁾).
for x=ac or x=p an “execution sequence of TT.x, ESTT.x” be defined as a complete sequence of tupels, “ESTT.x(t)”, of all its references to Cj values, 1≦j≦jC, of an execution of this TT.x in a “functional system”, being an executable system, the functional specification of which are this TT.x's fundamental facts.

Then the above DNC relation exists also between any TT.ac and TT.p and is defined as follows:

“TT.ac discloses TT.p” iff for some ESTT.p an ESTT.ac is disclosed with: ESTT.ac=ESTT.p (for all tεRP), i.e.

“TT.ac not-discloses TT.p” iff for no ESTT.p an ESTT.ac is disclosed with: ESTT.ac=ESTT.p (for all tεRP),

“TT.ac contradicts TT.p” iff for any pair <ESTT.ac, ESTT.p>holds: ESTT.ac≠ESTT.p (for at least one tεRP).

I.C The determination of the attributes X).n and X.i).n of the elements X and X.i of a PTR's TT.p and TT.i's requires some clarifications regarding the different kinds of disclosures in a patent specification concerning its TT—be this patent dealing with a technical or non-technical subject matter.

Without going into details, any such disclosure in a PTR's document disclosing a TT.p or TT.i,
(1) may therein take place explicitly or implicitly. I.e.: It must be explicitly provided in this document's specification/drawings/claims wordings and/or explanations or it may take place in this document's implicit use of skill (which itself had to be documented, see Section III) and then need not be explicitly provided therein.
(2) must be checked, in any document.i, for relevance with respect to at least one of TT.p's attributes (i.e. whether it contributes to anticipating or even excluding TT.p by a TT.i) or else is irrelevant. Thus, an FSTP user determining the fundamental technical facts of the TTs, need not care for the in this sense irrelevant disclosures—except that no such otherwise irrelevant component must be contradicted by a cM (see footnote 14). I.e., with this exception only disclosures of “TT.p relevant” components of the X.i).n's are considered in an FSTP analysis.
(3) may refer, in a document.i, to one or several TT's, if it discloses more than one TT.i—which all may be completely reflected or not in its claims section, or which there may even be modified. The so arising questions are ignored here—though generalizing the FSTP such as to make it indicate such factual differences is an activity easily performed by anybody skilled in the art (see Section III).
(4) must be a “free” limitation of its TT—i.e. is not implied by another limitation. I.e., it must not represent a logical consequence of some other explicit or implicit limitation imposed already on this TT (e.g. as implied by any implementation of it). Then this disclosure is not additionally affecting a functional or non-functional property of this TT and is therefore totally ignorable.

Determining by an FSTP and/or its user for a PTR all the relevant X).n and X.i).n—which comprises qualifying these documents' disclosures according to (1)-(4)—are activities, which are all but trivial and yet, in the end, the user thereby must often be left on his own. But: While no generally applicable user guidance is possible for performing this activity, when dealing with subject matters in specific “application domains”, an appropriate DSL (=domain specific language) may be available, which may considerably support the user in performing this task—and also facilitate the judicial review, whether this translation of these disclosures into fundamental facts described in this DSL is correctly and completely performed. The translation of this DSL attribute description into a mathematical facts description consisting of the above X).n and X.i).n, for which an automatic prover is capable of determining the existence of the above not-discloses-/contradicts-relations between them, then would be performed automatically by a DSL compiler or interpreter, as they are broadly known in SW engineering—though no such DSL of the kind required here is available yet for any PTRs' subject area (see Sections I.F and III).

I.D This section highlights the differences between having the FSTP analyze a PTR by

on the one side, its TT.p's main claims' natural language wording (as elaborated on in Section II.A.1.1), and

on the other side, the formal attribute presentations of its TT.p and its TT.i's (i.e. their fundamental facts), i.e. explains, why the PTR's formal logic “FSTP analysis” (as elaborated on in Section II.A.1.2) provides factual indications of normally much higher significance (e.g. for a judicial decision concerning its TT.p's nonobviousness over its RS) than the classical natural language “limitations analysis” of TT.p's claim and its alleged natural language (partial) disclosures in some TT.i's—i.e. why it provides, in addition, much more powerful indicative facts.

Achieving by the FSTP such advantages concerning a PTR analysis, i.e. new insights into the PTR's nontriviality/nonobviousness problem, by transforming this problems presentation into another presentation system—as it is done here, by transforming all disclosures in natural language presentation in the PTR into a logically equivalent mathematical presentation—is not new. In particular in physics, it is commonly known that additional fundamental insights are achieved this way, e.g. in many
elementary particle physics problems by transforming their original “deterministic” presentation into a “probabilistic” presentation,
electricity problems by transforming their original “real numbers/functions” presentation into a “complex numbers/functions” presentation,
signaling problems by Fourier transforming their original “space” presentation into a “frequency” presentation,
celestial mechanics problems by transforming their original presentation in the geocentric coordinate system into e.g. a solar centric coordinate system.

A similar advantage is obtained from transforming the presentation of a PTR's nontriviality/nonobviousness problem from its original natural language presentation to an appropriate formal attribute presentation (see Section II.A.1): Then new fundamental insights into it are derivable, as this presentation allows automatically taking into account—by its FSTP analysis—the Highest Courts' precedents concerning this problem, as these are also easily transformable into this attribute presentation (see Sections I.E and II.A.2).

In doing so, the FSTP also leverages on some basic and long-time known insights from IT sciences:
I.D.1: For determining the meaning of a claim's wording, i.e. interpreting it semantically, a precise determination of the TT.p's meaning is indispensable, to which the claim's wording refers: Since dozens of years it namely is commonly known by all linguists, language translation technicians, knowledge engineers, . . . that dependably determining the meaning of (=interpreting) a sentence of some known syntax, e.g. a claim's wording of English syntax (i.e. in the English language's vocabulary and grammar) is impossible without deriving this meaning from its “semantics association base”—in case of a patent's claim wording being its TT.p's semantics description¹⁾. ¹ In interpreting a patent's claims wordings, the US precedent supports using disclosures of the patent's specification only if the claim uses the “means plus function” legal construct—while the precedent of the German BGH requires first identifying the TT.p's semantics from the patent's specification (as its resolution of the problem it put forward) and then to perform the claim's interpretation based on this TT.p (see Section II.A.1.2), and thus is in line with Article 69 of the European Patent Convention (EPC). I.e.: In an FSTP analysis, the patent claims' semantics association base is its TT.p's semantics description (in what presentation so ever, see Section II.A.1), as disclosed by the patent's specification/figures/claims.
I.D.2: Any presentation's attributes contain references to values of independent concepts (see Sections I.A and I.B). A large number of attributes and such concept references imply a complexity making impossible their dependable analysis by a human being without any technical support. This particularly applies, if a TT.p is located on high levels of abstraction/nonvisuability/specificity, as it inevitably is the case with any TT.p representing a “holistic” invention: This TT.p integrates meeting the vastly diverging requirements resulting from the concepts of the invention's a) subject, b) reproduction, c) users' needs, d) applications' features, e) . . . .

I.e.: Once a PTR shows this complexity, keeping it dependently under control is possible only by using a technical support tool, such as the FSTP.

I.E This Section clarifies the two decisive and fundamental differences between the FSTP's “Highest Courts' precedents integrated” innovations versus other scientific “no precedents integrated” academic research on the obviousness problem in national patent systems. These two fundamental differences show why none of these researches had only the faintest chance of recognizing that something like the FSTP were of interest, not to speak of one of them having actually disclosed anything alike.

German such prior scientific research efforts are e.g.:

“Die Beurteilung der Erfindungshöhe mit Hilfe der Informationstheorie”, H. Ölschlegel, GRUR 1964, and

“Recherche and Prüfung einer Erfindung auf Patentfähigkeit”, H. Beyer, GRUR 1986,

which—regardless of their outstanding qualities—nowhere come close to the FSTP. In hindsight the two fundamental reasons are obvious, why this unbridgeable big gap exists between this kind of prior art research and the FSTP invention: The FSTP analysis of a PTR can leverage on the knowledge that
I.E.1: Highest Courts' precedents identified²⁾ the fundamental constituents of technical secondary facts. ² In the various national patent systems, their precedents performed these identifications more or less explicitly or implicitly: Their Highest Courts in principle always count (see the next paragraph) or at least to ask for (see the US Supreme Court's KSR decision), whether the number of independent creative ideas is definitively larger than 1, which are indispensably required for expanding the prior art RS by modifying its attributes such that, starting from this RS, this technique teaching TT.p (being analyzed) may be reached, i.e. is achievable by an anticipation-combination (see footnote 13) over the so expanded prior art RS. The X^{th} Senate of the German BGH elaborated, already since its 1999 ground laying “Spannschraube” decision, in 2 dozens of decisions on the indispensability of first determining this TT.p—for clarifying the meanings of a claim's technical terms and performing this patent/claim interpretation only on this basis¹⁾ and how the latter may be affected by the former. On this firm basis it explicitly identified the notion of “several mental steps”—here called “thoughts” and even tightened to “independent thoughts”—in its “Gegenstandsträger” decision, after having identified such “independent thoughts” implicitly already in several of its preceding decisions recognizing the nonobviousness of a TT.p.

None of the prior scientific efforts tried to determine for a PTR, what a creative idea—i.e. what the fundamental constituent²⁾ of a technical secondary fact is—which

I.E.2: enables the definition of legally meaningful “height/distance q” of a TT.p over/from a prior art RS.

Thus, none of the prior scientific efforts had a chance to determine for a PTR, whether—by repeated application of the pertinent Highest Courts' precedents identifying the notion of a “creative idea” (more or less explicitly)—for the resulting value of q holds:
q=0, thus indicating this TT.p's triviality/obviousness over RS, or
q>0, thus indicating this TT.p as nontrivial/nonobvious over RS, whereby the “power” of this indication increases with the value of q increasing,
whereby also the structure(s) supporting this value of q are important—i.e. the q-anticipation-combination(s) of TT.p over RS (see the above ABSTRACT and the Section I.H, for details the Section II.A.2).
   I.F In addition to the differences between the just explained kind of prior scientific research and the “FSTP technology” developed here, also a difference exists between this new technology and another kind of scientific research dealing with patent issues as understood by knowledge engineering. The subsequent elaborations are sufficient to clarify the today's fundamental differences between the here presented technique teaching resolving the FSTP's “(non)obviousness indication” problem for a patent, as discussed here, and other—indeed to it related—results of academic research dealing with the general problem of analysing/managing knowledge, which today is being modelled by ontologies, in particular if this knowledge is focussed on the subject area of patents. The state of this research makes it useful for facilitating dealing with a patent's (i.e. its PTR's) nonobviousness problem, i.e. for the recognizing the results of the patents' automatic textual analysis, e.g. of their documents' specific universes (see footnote 18 and FIG. 3) and in any document all the references to any of the concepts of this universe. This state may long-term be developed so far that its full integration into the FSTP is achievable—then making obsolete a good deal of the input the current FSTP requires to be provided by its user.

From the area of research on ontology systems and related technologies, potentially helpful for meeting general patent indexing and/or mathematical or logical needs within it, outstanding surveys and papers are:

U.S. Pat. No. 5,694,523, Wical, 1995: Oracle Corp., shows the patentability of such patent oriented inventions,

Patent Application US 2008/0021700 A1, Moitra, 2006: Lockheed Martin Corp.,

“A . . . . Platform for Invention Based on Ontology and Patent Document Analysis”, V. W. Soo, 2005: 9^{th} ICCSCWD,

“Automatic Patent Document Summarization . . . ”, A. J. C. Trappey, 2009: J Syst Sci Syst Eng,

“Auf dem Weg zum Begriff—Vom Rechtswort zur Rechtsontologie: . . . ”, D. Liebwald, 2009: d(a) Liebwald.com,

“mArachna—Semantische Analyse der mathematischen Sprache . . . ”, N. Natho, 2009: natho@math.tu-berlin.de.

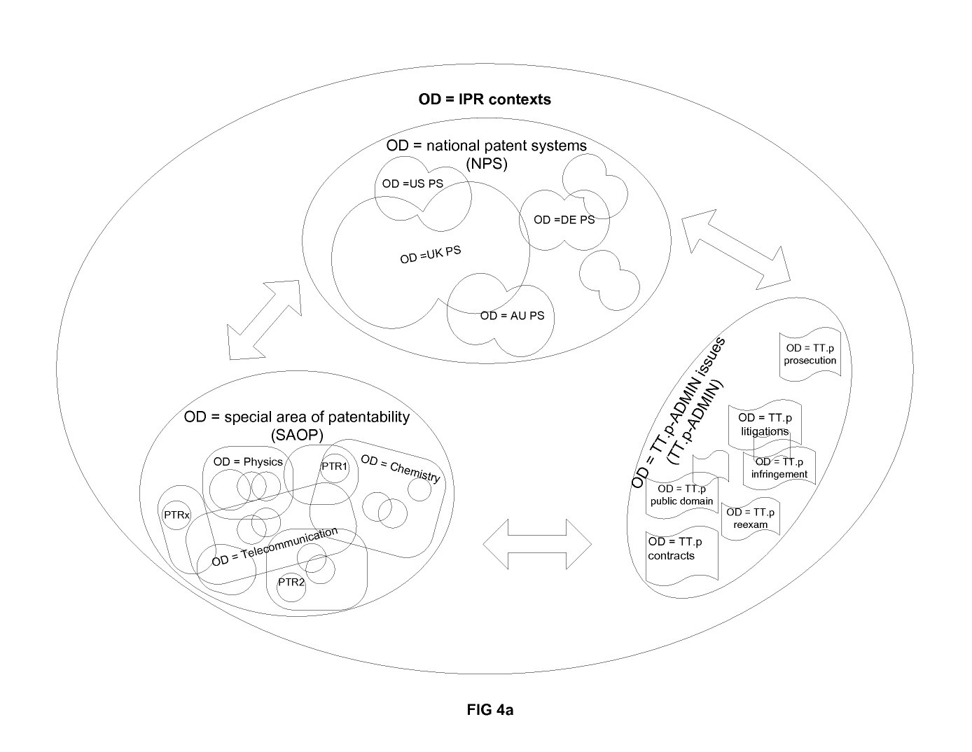

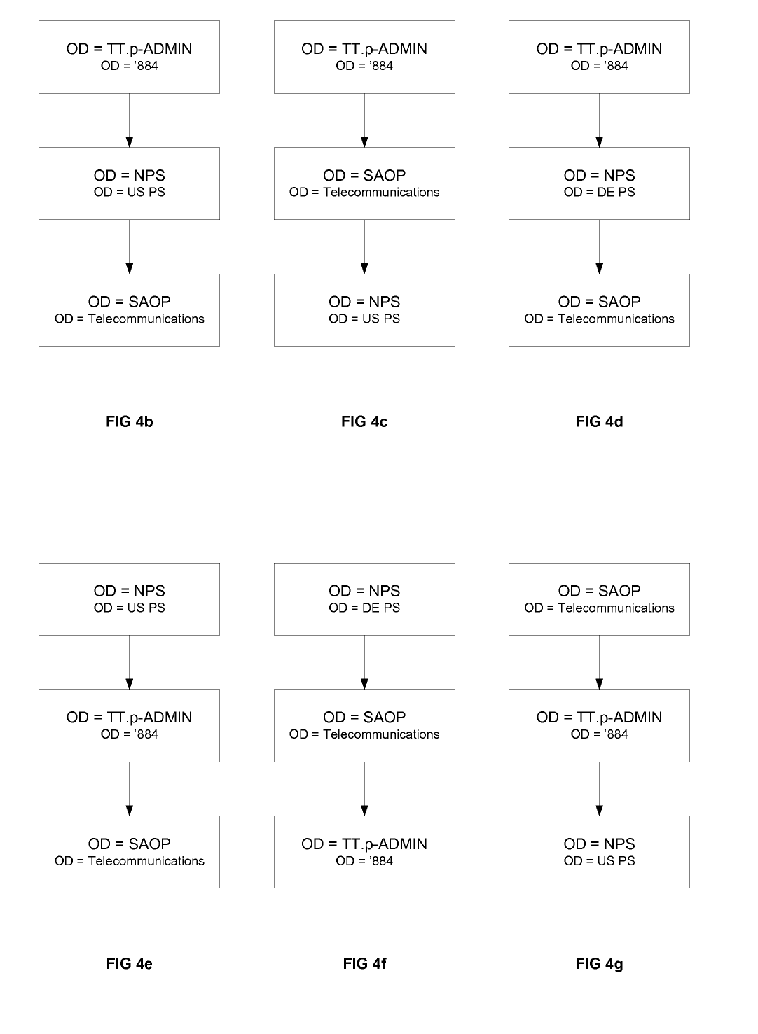

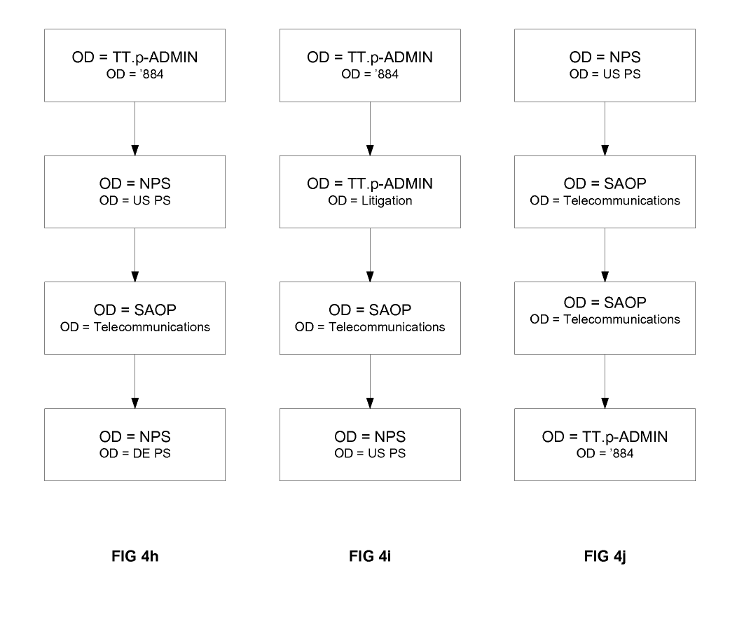

All six surveys/papers indicate that the FSTP approach to the nonobviousness problem of a PTR is tackled nowhere else: Namely, none of these ontology research activities considers the specific type of problems arising on the “FSTP way of thinking” and/or the specific type of contexts providing support needed for resolving them conveniently/efficiently/internationally. This way leads the user, when using the FSTP in analyzing a PTR for nonobviousness/nontriviality, straightforward to (semi)automatically get resolved—quantitatively and qualitatively—
his PTR's anticipation-combination problem¹³⁾, i.e. get clarified whether its allegedly innovative TT.p is combinable over its prior art TT.i's¹³⁾, and otherwise his problem of determining the semantic height of its TT.p over the semantics potential of the pertinent prior art represented by its RS,
both as modeled by and related to the respective subject matter ontologies (see the end of Section III),
   whereas the current scientific ontology based research activities don't address these two specific semantics driven/managing problems. Their very strong points are that their techniques allow providing the global contexts to the FSTP and that they will soon be able to automatically screen the huge amounts of potential/alleged prior art documents for facts reliably excluding the relevance of most of them in a patent case (see the introduction to Section II).
   I.G The differences between these prior scientific research activities (on the one side in Section I.E and on the other side in Section I.F) and the FSTP technology are visualized primarily by the FIG. 4.

FIG. 4a is supposed to show that the FSTP—whenever using it in creating/developing/analyzing/administrating/managing/ . . . a TT.p—semi-automatically permanently supports taking into account the impacts on this activity by in particular three nontechnical contexts (modeled as “context ontologies”): The “national patent systems, NPS” context (including their Highest Courts precedents ontologies), the “subject areas of patentability, SAOP” context (including the subject matter ontologies of the FIGS. 2 and 3), and the “TT.p administration processes” con-text (including its prosecution and litigation histories)—being modeled as “NPS context”, “SAOP context”, and “TT.p-ADMIN context” ontologies. I.e.: Any such TT.p-ADMIN activity occurs within some NPS and SAOP contexts.

The functional presentation of these context ontologies as separate entities should not be misunderstood as limiting their implementation structures: Their technical embodiments—obviously being data base systems—may be vastly overlapping each other (i.e. be implemented as one single data base) or may be split into even smaller functional entities, whereby each entity contains only a certain type of ontologies as included in its “mother ontology” and is implemented as separate data base for anyone of them. And this conglomeration or decomposition of functional entities respectively their “data base engines” again does not imply their particular centralized or distributed physical implementation (see the below explanation of FIG. 1c).

At short notice the “global” context ontologies would be incomplete, while right from the beginning all the knowledge about a specific TT.p/PTR being FSTP analyzed may be provided completely by its user. In both cases, an FSTP embodiment would enable its user to browse conveniently through all the knowledge available to it as needed by him—even if no global context ontology is known and/or available to it, at all—using the FSTP's various technical knowledge presentation functions as outlined in FIGS. 1b and 1c.

The context ontologies of FIG. 4a establish the determinants of the so—i.e. by means of the respective NPS and SAOP context ontologies—definable anticipation-combination respectively semantic height problems for the PTR, from which the FSTP derives its above results in a facts screening and transforming process, as visualized by the FIG. 5 showing this process's functionalities and sequences of steps of evoking them (see below). Although there is no static hierarchy between the context ontologies, any use of the FSTP would stack them according to their sequence of evocation, thus implying dynamic hierarchies between them. I.e.: After starting with working on a specific issue in the TT.p-ADMIN, the FSTP user would be able to select an arbitrary one at a time NPS and an arbitrary one at a time SAOP—both then subordinate to TT.p-ADMIN. And the corresponding holds while he is updating some NPS ontology or some SAOP ontology (see FIGS. 4b-d). The corresponding also holds after starting with a specific issue in some NPS or SAOP and continues in TT.p-ADMIN (see FIGS. 4e-g and 4h-j).

I.H The main purpose of this section is to emphasize the FSTP's indispensable need, use and control of hardware systems highly specialized by their application customization software, which are specifically designed for this purpose and dedicated exclusively to the FSTP—in addition, it outlines how these FSTP specific devices and their functionalities interact with each other—by explaining primarily the FIGS. 1b-c.

FIG. 1b schematically shows, firstly, the functional structure of the peripheral components 1b.1, 1b.2 and 1b.3 of any technical embodiment of the FSTP: Its peripheral components temporarily store the information actually input to and/or output by its central components 1b.20 and transform it from/into its

physical presentation 1b.4, 1b.5 and 1b.6 actually producible/comprehensible by its users to/from its

physical presentation actually used by its central presentation system 1b.21 for interacting at its interfaces 1b.7, 1b.8 and 1b.9 with the peripheral components.

Secondly FIG. 1b schematically shows the functional structure of the central components 1b.20, including their working set: In addition to the central presentation system 1b.21, managing the various users' information presentation, the central management system 1b.22 of the various users' different working sets including the latters' access rights to the FSTP's ontologies (as exemplified in FIGS. 4b-j). While the components outlined so far the implementation structure of (part of) the access functionality to the FSTP's knowledge transformation functionalities—and not yet of the FSTP's Internet access functionality of FIG. 1c—its central components also comprise the working set's local version of (the global) ontology domain systems (augmented by local processing capacities), on which the FSTP performs its two knowledge transformation functionalities described in Sections I.A-E and I.F-G, both elaborated on by the disclosures of the subsequent claims, and summarized in Section I.J. These 2 knowledge transformation functionalities perform, on a user's working set, the screening (1b.23), transformation (1b.24), identification (1b.25) and integration (1b.26) functions, as disclosed by the subsequent claims. These functions and the local ontology domain systems are technically highly specialized such as to perform in user acceptable times their respective functionalities, which requires—due to the exhaustive searches implied by the claims—a
physically specific organisation and management of its information on each of them (e.g. by establishing appropriate access methods to its items, as required by the subsequent claims and the users input) and a
physically specific message passing system between them,
   as, triggered by a single command of the working set's user, exemplary semantics of which are partially outlined in FIGS. 4b-j and 5b, these 4 systems must be able to jointly perform millions of search operations implied by it.

FIG. 1c finally schematically shows the Internet access capabilities of the FSTP component systems—of the FSTP's peripheral components 1c.1-5 (on top of some www browsers), of the FSTP's www Server 1c.10 (e.g. on Apache basis), of several FSTP's central components systems and their working sets 1c.11-12—and the latters' use of external (i.e. non-FSTP) data bases and/or knowledge bases (not elaborated on, here).

I.J A summary of Section I thus has to state that the FSTP, in total, deals with 2 quite different kinds of factual knowledge transforming semantics: Its
I.J.1: “PTR to technical secondary (basic and structured) facts” knowledge transforming semantics—outlined by Sections I.A-I.E and described in detail by Section II, and its
I.J.2: “Any TT.p detail to all its relevant contextual details and vice versa” knowledge transforming semantics—described in detail by the preceding paragraphs and their figures, whereby these contexts are provided by global contexts and the subject area contexts of I.J.1. The user may arbitrarily toggle between arbitrary contexts anytime and work on them as needed, thus in particular possibly building up for “activity logging” ontologies suitable presentations to the user, both as defined by him.

Insofar the FSTP can be viewed as a convenient patent expert system of a very specific kind, in that it is always and instantly capable of determining for its user and for any PTR known to it especially all the “technical secondary facts” and all related information concerning this PTR—wherever they/it may be founded or derived or used in whatever contexts and why. And this is the “second centre of gravity” of this document—besides determining these technical secondary facts of a PTR, being its “first centre of gravity”—namely providing all the technical means required for being able to simply and efficiently manage all the knowledge related to patents, and in particular the technical decisive (as legally justifying their existence) but very complicated knowledge about them, as well as all the interrelations between the different kinds of patent knowledge.

These two quite different knowledge transforming semantics of the FSTP—as presented in this Section I—allow recapitulating the main distinctions between it and any other knowledge technologies based patent/venture research activity by two simple sentences: None of them
addresses the most difficult mental and legal question in patent law—and being the first focus of the FSTP—namely how to provide facts that indicate the degree of the legal stability of a patent concerning its technical nonobviousness, or
considers the most urging requirements to be met in managing the whole ontology of a patent (arranged around its just mentioned legal stability in the national legal systems)—being the second focus of the FSTP.

### II. THE FSTP BASICS—ITS APPLICATION IN A CONCRETE PATENT CASE

The basics of the FSTP and its use are now explained by applying it to claims 1, 2, 17—based on the TT.p underlying them—of the European “'884 patent” (EP 0 929 884 B1³⁾) and the below quoted 16 documents.i³⁾ as RS, but all elaborations hold even stronger for the claims of three US patents³⁾ of this patent family. ³ While the '884 claims section is provided also in English, the English version of its specification is provided by the U.S. Pat. No. 6,954,453 B1, being the reference base in all subsequent quotations from the specification. The US patents U.S. Pat. No. 7,145,902 and U.S. Pat. No. 7,483,431 are divisionals of the '453 patent, i.e. have identical specifications. Consequently this paper is independent of the particular one of the above 4 patents, except for claims differentiation, as they all disclose by their identical specification the same TT.p. The selection of these 16 documents—out of a total of approximately 50 allegedly prior art documents, submitted to the BGH in a nullification against the '884 patent—is based on a decision by the BGH. These are: doc.1=WO 90/12466, doc.2=U.S. Pat. No. 5,347,516, doc.3=Lucent, doc.4=doc.12, doc.5=JP7-154426, doc.6=JP57-159153, doc.7=doc.8, doc.8=IDB-64/2, doc.9=Malek, doc.10=Wacker, doc.11=AVM, doc.12=U.S. Pat. No. 5,517,662, doc.13=Lee, doc.14=U.S. Pat. No. 4,977,556, doc.15=U.S. Pat. No. 5,479,650, doc.16=WO 96/28947. The non-patent document.i is available by the author.

Quite generally speaking, the FSTP works fundamentally different from the standard judicial procedure of determining facts indicating the technical (non)obviousness/(non)triviality of a TT.p over some RS: It namely applies some Highest Courts' precedents (in particular the BGH one) by using some formal logic (only at a most elementary level)—i.e. a highly automatable technique so far unknown in the patents' contexts. This does not only improve the FSTP's undoubtability/objectivity and reliability/completeness in identifying such technical facts and their analysis, as disclosed by these 17 documents, but it also enables recognizing the “indicative power” of these facts.

This FSTP achieves its facts determination for a PTR on two stages (as repeated in more detail below):
On its 1^{st} facts determination stage, explained in Sections II.A.1.1-4, all relevant formal attributes X).n and X.i).n are determined and then all the discloses/non-discloses/contradicts relations between them. I.e.: The result achieved at this 1^{st} FSTP facts determination stage is a matrix, called “EDNC matrix”, which shows for each attribute X).n of each TT.p element and its peer attribute(s) X.i).n in each document.i, which precisely of the 3 relational facts holds between X.i).n and X).n therein on the “element” level: the
   “discloses” relation saying: at least¹¹⁾ one X.i).n discloses X).n (“D”),
   “contradicts” relation saying: any disclosed or contradictionless¹³⁾ inventible X.i).n contradicts X).n (“C”),
   “not-discloses and not-contradicts” relation saying: none of both preceding relations holds (“N”).
On its 2^{nd} FSTP facts determination stage, its
   “basic functionality”, explained in Section II.A.2.1, derives from the DNC matrix whether there is an anticipation-combination, TT.ac, of disclosures of RS, which achieves the TT.p (see Section I.B), in particular if a “sub-patent law cM” of one of these disclosures is granted. This basic functionality thus determines the “conventional”/“classical” technical secondary “basic fact” (here: indicating the nonobviousness of the '884 teaching over the 16 document.i⁴⁾), and its ⁴ In general, this determination is tedious, but it is trivial in the '884 case, as the '884 EDNC matrix will show on first sight. “inventive height determination functionality”, explained in Section II.A.2.2, derives from the “concept based”—and thus substantially refined—“CDNC matrix” a new, much indications-stronger technical secondary “structured fact”, which is an integer giving the “semantic height of its TT.p over this prior art” and a set of “shortest ways to achieving/inventing TT.p starting from this prior art, as defined by its RS”.
   “inventive height determination fucntionality”, explained in Section II.A.2.2, derives from the “concept based”—and thus substantially refined—“CDNC matrix” a new, much indications-stronger technical secondary “structured fact”, which is an integer giving the “semantic height of its TT.p over this prior art” and a set of “shortest ways to achieving/inventing TT.p starting from this prior art, as defined by its RS”.

Two remarks are added concerning the FSTP's way of analysing a patent's claim(s):
As compared to the conventional patent claim interpretation, the FSTP facts determination avoids relying on
   arbitrarily interpretable fragments of sentences, such as context-free “limitations” in a patent's claims, i.e. ONLY on word spotting in it, but it insists in crosschecking with the TT.p underlying it, being the patent's new solution to the problem it describes to be solved (as outlined in Sections I.A and II.A.1.1-2) but
   vague arguing in natural language only, but is based directly on formal logic. The former does not allow an automatic and unquestionable discrimination between true and false facts assumptions concerning the DNC relations between a TT.p and its prior art, between logically correct and false arguments about them: it cannot instantly prove, for the jurists evaluating them, arguments concerning the relations of the prior art to the TT.p as being false⁵⁾, i.e. as wrong or true—while the FSTP therefore can. ⁵ This is known at the latest since Wittgenstein's cognition theoretical research on ambiguities of natural languages—also see¹⁴⁾.
In its basic functionality the FSTP facts determination is equivalent to the conventional facts determination, i.e. it is nothing else but a formal-logic presentation of the usual decision practice of national Highest Courts: It starts from the same prerequisites as the latters, namely from the same disclosures in all the documents, and arrives at the same results as these—assuming both sides work correctly—concerning any facts indicating the novelty and/or the (non)obviousness of the TT.p over the given prior art. In its inventive height determination functionality (of a TT.p over prior art) the FSTP screens exactly the same disclosures, but much more carefully, namely for the independent concepts restricting them and their uses—which are the decisive ingredients of creativity—and thus manages to derive much better factual insights concerning the (non)obviousness of TT.p.
   II.A The FSTP's Determination of the Conventional and New Technical Secondary Facts—Exemplified by the '884 patent

The first parts of this Section II.A explain in simple words the FSTP application, i.e. the “FSTP analysis”—in particular: to the European '884 patent and the RS consisting of the above 16 document i's (see³⁾ and the very beginning of Section II), i.e. to the '884 PTR—as well as the indicative power of the technical secondary facts delivered by this analysis. In order to allow this simplicity in dealing with technical secondary facts, this Section II.A sets out the determination of all document specific facts determinations into Sections II.B and II.C. In addition, Section II.A is split into the Sections II.A.1 and II.A.2, explaining separately the FSTP application's 1^{st} resp. 2^{nd} facts determination stages. The 1^{st} section (i.e. the explanation of the 1^{st} facts determination stage) is split into four parts, II.A.1.1-II.A.1.4, and the 2^{nd} section (i.e. the explanation of the 2^{nd} facts determination stage) into two parts, II.A.2.1 and II.A.2.2, whereby the latter falls into Sections II.A.2.2.a and II.A.2.2.b.

FIG. 5a identifies the various functionalities inevitably involved in determining for a concrete PTR (e.g. the '884 PTR) all its technical secondary facts (see the beginning of Section I) by its FSTP analysis. The functionalities on the top therein indicate that it must be performed almost totally by the FSTP user, as explained in Sections II.A.1.1 and II.A.1.2. All the other functionalities are part of the FSTP, as shown by FIG. 1b. FIG. 5b shows that these functionalities are evocable in almost arbitrary sequences of steps—evocations being arrows—whereby the “reliability of the value of q” in the stop condition is to be decided by the FSTP user.

II.A.1 The 1^{st} FSTP Facts Determination Stage and the EDNC Matrix—Exemplified by the '884 patent

The following Sections II.A.1.1-II.A.1.4 try to make aware—by general terms and by means of the '884 patent example—that, also for the person of ordinary skill in the pertinent technical arts, it is (almost) never absolutely trivial to grasp correctly and completely the meaning of a patent's TT.p, and hence grasp the precise meanings of the technical terms it uses in its disclosures of its TT.p (see¹⁾). This is particularly true, if these terms are frequently used with quite differing meanings in a broad range of documents, as typically is the case with communications technology and its very basic technical terms, such as “switch”, “network”, “change over”, and “signal”. Then reading these disclosures twice is indispensable also for him, just for finding out, what meanings are disclosed (in the patent specification) to be associated with them in its TT.p (see Section I.D.1 above).

In the '884 case more than 50 documents were submitted, all allegedly anticipating the '884 TT.p—although associating totally different of each other meanings to these 4 basic '884 terms, whereby not a single one of them comes close to its peer '884 meaning—see the EDNC/CDNC matrixes below for the 16 document.i chosen out of these more than 50 ones by the German BGH. For attempts to avoid such nonsense see Section I.F.

II.A.1.1 Correctly Getting the Technical Philosophy of a PTR's Technique Teaching, TT.p—General Hints

The first step for avoiding such a mistake is a preparatory activity before really using the FSTP, i.e. to be performed by the FSTP user prior to using it for its much more sophisticated analysis of the PTR. It consists in assessing the correctness of understanding the “technical philosophy” of a patent's invention alias TT.p to be analysed by the FSTP—which is easily performed by the skilled person in the art, simply by reconsidering the patent's disclosures concerning this TT.p. The FSTP might help here by some of the well-known means of automatic textual analysis of the patent (i.e. by indexing it, marking it up accordingly and/or hinting at some possible semantics for the constructs marked-up, as indicated by the patent and the patent application in Section I.F), thus at least helping avoiding some potentially relevant wording are missed. Today deriving the TT.p's technical philosophy from this textual analysis remains with the FSTP user—thus initially misleading the FSTP analysis of the PTR. Getting this technical philosophy wrong, i.e. failing to understand one of the invented technique teaching's fundamentals is one of the most common reasons for controversial patents' discussions in court cases.

Frequently, it is not possible to precisely and/or completely terminate this first analytical activity on a patent's TT.p before having completed the subsequent application of the FSTP to its PTR, due to two reasons:
Questions concerning this technical philosophy of the TT.p may arise only that late, when an exhaustive search for an anticipation-combination for the TT.p brings them up—as this search by an automatic reasoner/prover may check by formal logic (i.e. completely and precisely) the potentially large number of chances to eventually arrive at an anticipation-combination, which normally (both) is not possible to a human's mind—and
quite new additional such questions about it may arise, as an additional document.i is added to the PTR's RS, potentially opening new chances of eventually arriving at an actual not-changed anticipation-combination for its TT.p, thus bringing up questions considered irrelevant over the previous prior art RS (see Section II.C.16).

Thus, getting the TT.p's philosophy right may require an iterative process to be started with a technically wrong TT.p—which then would be elaborated on and inevitably corrected, as the iterations arrive at identifying and using the PTR's universe for resolving the patent's problem (see footnotes 1, 2, 13, 14, and 18).

II.A.1.2 Correctly Getting the Technical Philosophy of a PTR's TT.p—Exemplified by the '884 patent

The purpose of this section is to demonstrate the absolute need, also for a person skilled in the art, not to instantly jump at an alleged technique teaching of a patent at the first feeling of having grasped its working—as it frequently would arise from reading just its claim's wording—but to dispose any such alleged TT.p of the patent, if it does not resolve the problem put by the patent's specification to be solved by this TT.p. This implies recognizing a so disclosed alleged TT.p to be the factual TT.p only if it does resolve this problem, i.e. to impose on the TT.p the limitations concerning its working in order to make it achieve this solution as disclosed in the patent specification.

The absolute need of this measure of precaution in determining a patent's TT.p, i.e. when interpreting this patent—see Protocol on the Interpretation of Article 69 of the EPA and footnote 1—is subsequently proven by means of the '884 patent. This '884 demonstration clearly exposes the unexpected and really dramatic discrepancy between
an initially assumed alleged TT.p, as resulting from imposing only the '884 claim's limitations on it, and
the lawful/factual '884 TT.p, resulting from additionally imposing on it the limitation/requirement that it got to be the resolution of the problem described in the patent specification—it then represents the patent's invention.
   This discrepancy is the predominating reason for most of the controversial arguing in patent court cases—while such arguments technically always may be put that simple as to be immediately graspable by non-technicians.

To begin with showing this dramatic discrepancy: The English wording of claims 1 and 2 of the '884 patent in cols. 20-21 contains the 4 elements/terms “switch”, “packet-switching network”, “change”, and “signal”, limiting their meanings at least to: “ . . . transmitting data from a first switch to a second switch . . . ”, “ . . . packet-switching transmission of the data packets over the packet-switching network . . . ”, “ . . . checking whether there is a control signal for transfer to a line-switching connection to the second switch, whereby this signal is emitted by the user of an end device or a network management . . . ”, “ . . . changing to a line-switching data transmission . . . ”.

From these '884 claim limitations follows undoubtedly that the alleged '884 TT.p is a data transfer procedure between two switches over alternative networks (the word “procedure” mostly being left out for brevity). In addition, the '884 specification clearly states the “'884 problem” to be resolved by the '884 TT.p: It got to be “ . . . a data transfer substantially in real time . . . particularly important for Internet telephony.”⁶⁾ (col. 3:59-62), as confirmed by the '884 claim 8 and additionally by e.g. cols. 2:7-14, 3:13-14, 3:21-25, 4:1-2, 7:24-25, 8:5-9. ⁶ The meaning of this “substantially in real-time” attribute of a data transfer is that it takes place sufficiently synchronous to the real life process(es), to which it refers, e.g. to a telephone call process. This synchrony need not be “absolute” but only “substantially”, as induced by the pragmatics of the process(es) referred to, e.g. of a telephone call. Therein the tolerable lag time of this data transfer during call set-up would be slightly longer than its tolerable lag time during speaking. But nevertheless, both tolerable lag times of a data transfer, which is suitable for Internet telephone calls, are subject to the real-time limitations of telephone calls. Consequently, none of the above 16 document.i strains, its data transfer would achieve real-time quality. See also footnote 19.

Everybody instantly recognizes that these few limitations of the '884 claim wording are insufficient for warranting the real time quality of an only by them enforced data transfer, even if only its data transfer between switches⁷⁾ were considered—as it quite obviously allows “non real time” data transfers, if namely the above '884 signal is not triggered (i.e. neither by a user nor by a network management) although the packet-switching network gets jammed totally. Hence, this “only '884 claim limitations enforced” '884 TT.p fails to meet the legal requirement to resolve the clearly stated '884 problem but contradicts all the above provided pertinent '884 disclosures (see¹⁾). ⁷ For not mixing-up this notion of “data transfer”, i.e. the whole '884 transfer process, with “transferring data” (in the communications connection considered, col. 9:47-51), the former is denoted by the term “transfer” (see col. 9:37), subsequently in capital letters. A TRANSFER comprises much more than just the actual transferring of data, namely e.g. the “change from packet switching to line switching . . . at the command of the control unit 71, a connection is made via the line-switching unit . . . all the incoming date of the communications connection considered are . . . directed through . . . but through . . . ”, see col. 9:42-53—what clarifies the (almost) synonymy of TRANSFER and communications connection. That this change of the monitored TRANSFER results from and affects only this communications connection considered is evident for the skilled person: Otherwise the line-switching connection/bypass might be not at all established or instantly overloaded after establishment, both spoiling the TRANSFER's above property i). Just for assessing a common understanding: The term “communications connection” stands for an abstract “communications application association” between the two communicating parties—hence its name. It belongs to the layer 7 of the OSI Reference Model (known by the skilled person), i.e. it is an abstract application connection alias L7-connection. In case of a telephone call it is the abstract telephony connection provided to its both parties by the abstract models of their telephone sets. In its technical realisation a communications connection therefore comprises all the data links between both its end terminals and the switches connecting these data links—i.e. it is an end-terminal-to-end-terminal connection, as opposed to a network connection, which underlies its switch-to-switch segment, whereby the switches and data links within the networks being used by it are irrelevant here (as substituted by their respective network connections). The skilled person knows the various activities in dealing with a technical realization of the communications connection (frequently denoted by the term “call”), establishing its technical realization (=call setup phase), using its established technical realization (=call usage phase), and tearing down its established technical realization (=call termination phase)—all that taking place on behalf of an existing communications connection (see footnote 8).

But this requirement to resolve the '884 problem is met by such a data transfer⁷⁾/TRANSFER, which
i) is also real-time quality preserving—as required by a telephone call⁶⁾—whereby this TRANSFER
ii) may cause generating the real-time quality preserving change-over signal somewhere (see⁸⁾) in the whole end-terminal-to-end-terminal communications connection—again as required by a telephone call⁷⁾—and ⁸ Such event of a time delay (implying a delay for ever and not regarding how the first switch becomes aware of it) may occur in various locations in the TRANSFER monitored and in a large number of situations. Examples of reasons of their possible occurrences are: The first switch is running out of buffer space as needed (e.g. for packetizing the data incoming from a telephone set) when using the packet-switching network for outgoing data of the communications connection considered, or it ran out of other recourses to this end (e.g. appropriate compression chip resources), or it cannot forward a packet to the packet-switching network (e.g. somebody has pulled the plug to it or it has encountered some internal management limitation), or it discovers—whereby the '884 TT.p need not explain to the skilled person, how to achieve this discovery—unacceptable delays/jitter on the data received by the second switch, or that the second switch has a similar problem as just identified for the first one, or . . . , whereby any of these events may occur as soon as the 1^{st} switch has performed any activity in this communications connection, which has come into existence as the 1^{st} switch has received from the calling end terminal the address of the end terminal to be called (see footnote 7). It is trivial by today—i.e. in hindsight—that the automatic release of a '884 change-over signal at any occurrences of this event does guarantee the real time quality of the '884 communications connection considered, i.e. of its '884 TRANSFER monitored, thus meeting the above requirement of warranting its col. 3:59-62 real time quality.
iii) generates the change-over signal depending on the TRANSFER within (i.e. by) this very communications connection considered and affecting only it—otherwise it were not real-time quality preserving⁷⁾,
   and there are two '884 disclosures of how the '884 TRANSFER achieves these 3 properties of its data transfers:
   col. 9:37-41: “ . . . change-over control device 711 . . . (a) monitor(s) the bandwidth of A TRANSFER and on (b) understepping or exceeding a certain bandwidth and/or in the events⁸⁾ of a time delay when forwarding IP data packets to automatically release a control command to change over . . . ”,
      and
   col. 9:43-52: “To change from packet switching to line switching, first at the command . . . a connection is made via the line-switching unit . . . with another switch . . . . After the connection is established, (c) all the incoming data of the communications connection considered are no longer directed through the IP-switch 72 but through the line-switching unit 73.”,
      which say⁷⁾: This TRANSFER meets i) due to (a) and (b), meets ii) due to (a), and meets iii) due to (a) and (c).

The '884 specification provides no further disclosure of how its data transfer could resolve the '884 problem. Thus these two disclosures' additional limitations are mandatory for the factual '884 TT.p—whereby their technical realization is much more demanding than anything then known from prior art. I.e.: There is a technically absolutely fundamental difference between the factual '884 TT.p and the “884 claim limitations based” alleged '884 TT.p.

Concerning correctly grasping the “technical philosophy” of a patent's TT.p, Section II.A.1 stressed so far:
It is absolutely inadmissible and unlawful to interpret a patent's claims by means of only their wordings and ignore assessing that the so implied alleged TT.p also indeed solves the problem put by the patent—in particular, if it discloses many limitations clearly contradicting this alleged TT.p (also see¹⁾).
It is absolutely indispensable for the TT.p to be lawful to assess that it actually solves the problem put by the patent, and that the disclosures in the patent's specification/figures/claims actually explain how this solution works (i.e. they are “enabling”), and that they are needed to this end.

### II.A.1.3 Precisely Presenting a PTR's Technical Fundamental and Primary Facts on the Element Level and the EDNC Matrix—Exemplified by the '884 PTR

In addition to what the preceding paragraph said, it is also known from system design techniques—in particular SW/HW technique—that these technical meanings got to be stated precisely, for a PTR's TT.p as well as for its TT.i's, prior to drawing conclusions from these meanings/semantics descriptions. Such precise meanings/semantics statements may be presented by identifying elements and their informal attributes (being the PTR's respective disclosures, see the beginning of Section I) and transforming the latter into formal attributes. These technical fundamental facts then also enable the FSTP to automatically perform its determination of this PTR's technical primary facts, including the EDNC/CDNC matrixes, and eventually of its technical secondary facts.

This Section I.A.1.3 elaborates on this “formalization on the element level” of presenting the PTR and the EDNC matrix—its formalization on the “concept level” and the CDNC matrix is briefly addressed in Section I.A.1.4.

The wordings of claims 1 and 2 of the '884 patent are based on 4 frequently used key terms alias elements in/of communications technology, X (A≦X≦D): Namely “switch” (X=A), “packet-switching network” (X=B), “change” (X=C), and “control signal” (X=D). The precise properties of these 4 '884 elements/terms resp. 4 peer element i's/term.i's in document.i, 1≦i≦16, are described by 15 attributes X).n resp. their peer X.i).n (A≦X≦D, n=a, b, c,). They define the here relevant aspects of the precise meanings of the '884 TT.p underlying these '884 claims resp. of their peer TT.i's, as disclosed in the 17 documents.

The 15 '884 attributes X).n are informally and incompletely described by catch words as follows:

A).a, as “Data transfer (DT) always between 2'884-switches and change at '884 signal” switch attribute,

A).b, as “At potential fault/loss of real time DT quality” switch attribute,

A).c, as “Change only of this communications connection and also during call set-up” switch attribute,

A).d, as “Direct telephone connection possibility” switch attribute,

A).e, as “Anytime start of the call DT by call set-up via packet switching network (PSN)” switch attribute,

A).f, as “Separate network accesses to PSN and line switching network (LSN)” switch attribute,

B).a, as “PSN is disclosed and is not the ISDN packet switching functionality” PSN attribute,

C).a, as “PSN-independent LSN—connection establishment” change attribute,

C).b, as “Retransmission-free user data PSN transfer” change attribute,

C).c, as “Delay time≦0.5 seconds” change attribute,

C).d, as “No initial consensus for PSN DT required” change attribute,

C).e, as “No later consensus for change to LSN DT required” change attribute,

D).a, as “External origin+2 generators or internal origin+many generation causes” signal attribute,

D).b, as “Binding trigger of change-over never affected by LSN non-accessibility” signal attribute and

D).c, as “Anytime trigger capability requiring no user information or any confirmation” signal attribute.

The details of the formal description of the 15 '884 attributes X).n are derived in Section II.B from dozens of disclosures provided somewhere in the '884 patent by its specification/figures/claims. Similar conglomerates of catch words had to be derived for anyone of the 16 document.i and the informal description of its peer 15 attributes X.i).n. The conventional facts determination argues by using such natural language fragments of sentences from the '884 patent and all 16 documents.i—which inevitably excludes any clean arguing, due to the commonly known deficiencies of any natural language¹⁴⁾. This also holds if these natural language disclosures are arranged somehow in tables (such as US “claim construction tables”, as the FSTP eventually will be able to generate automatically, see Section I.G), as no such arrangement can eliminate the problem, that ¹⁴ E. W. Dijkstra in ‘Teaching and Learning Formal Methods’, by C. N. Dean and M. G. Hinchey, Academic Press, 1996: “So-called “natural language” is wonderful for the purposes it was created for, such as to be rude in, to tell jokes in, to cheat or to make love in (and Theorists of Literary Criticism can even be content-free in it), but it is hopelessly inadequate when we have to deal unambiguously with situations of great intricacy, situations which unavoidably arise in such activities as legislation, arbitration, mathematics or programming.”
any such natural language presentation of the disclosures—describing the relevant aspects of the '884 TT.p as well as of the 16 TT.i's (if all the fragments of sentences are completed so that they unmistakably describe all the details of these 16 document disclosures)—is that voluminous/numerous that
all logical relationships between these numerous disclosures in natural language presentation can no longer be reliably mastered in several respects by a person of pertinent skill. This risk arises in particular as regards exhaustively searching for an “anticipation-combination¹³⁾ achieving the '884 TT.p over RS” (see Section I.B).

In order to avoid right from the outset the occurrence of this unmanageable situation in determining a PTR's technical facts—by transforming its presentation such as to make it manageable automatically by the FSTP (see Section I.D)—the FSTP analysis proceeds straightaway more meticulously and formally than known hitherto. In other words: Already on its 1^{st} facts determination stage (see the beginning of Section II) the FSTP
i) requires to translate the meanings of all the natural language disclosures—presented in fragments of sentence of the '884 patent and the 16 documents.i—into formal attributes, X).n and X.i).n, logically equivalent to them, i.e. into the PTR's “technical fundamental facts” (such that these formal attributes, X).n and X.i).n, alias technical fundamental facts, describe precisely the relevant technical meanings/properties for the respective 4 peer elements in each of the '884 PTR's 17 documents), and
ii) derives automatically all “discloses”/“not-discloses and not-contradicts”/“contradicts” relations between these elements X.i).n and X).n, i.e. the PTR's “technical primary facts”, saying which precisely of the 3 disjoint relations applies for the attributes X.i).n, n=a,b,c, . . . , i=1, 2, . . . , 16:
   “X.i).n discloses X).n”, i.e. “at least one peer attribute X.i).n discloses explicitly X).n”, or
   “X.i).n contradicts X).n”, i.e. “all peer explicitly or implicitly disclosed attributes X.i).n exclude X).n”, or
   “X.i).n not-discloses and not contradicts X).n”.
   thus delivering the below “EDNC matrix” on the element level (hence the initial “E” in its name) . . . .

Note concerning the determination of these technical primary facts: The TT.i of document.i and its attributes X.i).n need not be described formally if the person skilled in the pertinent art can ascertain immediately from the document.i disclosures, which of these relations apply for the peer X).n's—as it applies in the '884 case. Otherwise the X.i).n's must be described formally and the FSTP would automatically determine these relations.

Using formal attributes for precisely presenting the PTR's TT.p and its TT.i's (unless unnecessary) as required for the FSTP facts determination—unusual hitherto in patent law contexts, not practising this preciseness in describing the substance of the TT.P—is legitimized unrestrictedly by the transitivity law of logic in the form of:

“If holds: [symbol] = [symbol] and C.i relates_somehow_to [symbol] , then also holds: C.i relates_somehow_to [symbol] ” Here, each of the 15 formal '884 attributes [symbol] on the element level is logically equal to (see Section II.B) its natural language/graphics '884 disclosure, [symbol] , in total being the respective “informal '884 attribute”. Thus [symbol] = [symbol] .

Let C.i denote [symbol] 's peer “informal document.i attribute” consisting of the respective natural language/graphics disclosures in document.i. Section II.C then determines the EDNC relation between the informal attribute C.i and the formal attribute [symbol] . Therefore the same EDNC relation also holds—due to the above transitivity law—between the natural language/graphics document.i disclosure C.i and the natural language/graphics '884 disclosures

[symbol]

In other words: The formal attributes [symbol] are eliminable from the EDNC relation between the aforementioned peer natural language/graphics disclosures in the document.i, 1≦i≦16 and the '884 patent—i.e. do not affect the EDNC relation between them. Complementing the EDNC matrix such that it also showed the underlying original natural language/graphics disclosures of the X).n's and the X.i).n's would require only to make it 3-dimensional by adding a tower to each of its entries, i.e. 15 such towers to each line, i.e. by adding to each of the 15 formal '884 attributes X).n its respective tower of its natural language/graphics '884 disclosure, and applying the same to each of the formal 15 X.i).n entries of each of the 16 document.i.

Note that the 15'884-attributes [symbol] do not only create a precise understanding of the '884 TT.p by compactifying the mass of information of the natural language/graphics '884 disclosures defining it, but they also establish—as regards the determination of the aforementioned EDNC relation between the natural language/graphics disclosures in the '884 patent and the 16 document i's—a uniform reference system for all of them.

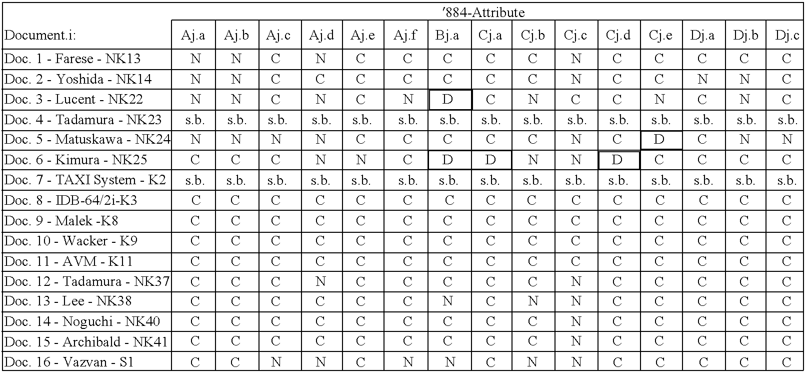

The advantages of this new presentation of all the relevant technical fundamental and primary facts in a precise attribute description are clear, if compared with the conventional procedure: The latter gets stuck with the natural language/graphics descriptions of the TT.p and of the “prior art” seemingly closest to it, and then immediately jumps at comparing the former's features with the latter's ones, based on all this mass of information presented in imprecise natural language disclosures¹⁴⁾: This conventional procedure therefore does not allow completeness or clarity or precision or reliability or structural insights or . . . as guaranteed by of the FSTP analysis.

The above EDNC matrix shows that of the 15 '884 attributes X).n

only 4 are disclosed and those only in 3 document.i, i.e. “all X.i).n's disclose only 4 X).n's”, and
11 are not disclosed in a single one of the 16 documents⁹⁾, i.e. “all X.i).n's not-disclose 11 X).n's”, and ⁹ These 11 '884 element-attributes are: A).a-A).f, C).b, C).c and D).a-D).c.

at least 7 are contradicted in each document.i, i.e. “7 X.i).n contradict X).n” for any “i”,

Whereby already only one of these 3 sets of technical primary facts suffices to indicate the nonobviousness of the '884 TT.p over the prior art (represented by the 16 document i's), as elaborated on next (see¹³⁾).

### II.A.1.4 Precisely Presenting a PTR's Technical Fundamental and Primary Facts on the Concept Level and the CDCN Matrix—Exemplified by the '884 PTR

As the explanation of the refinement of the FSTP analysis on its 1^{st} FSTP facts determination stage to the concept level (see Section I.A) contains some logic subtleties, it is postponed until Section II.A.2.2.b—although this violates the systematic of the document in hand, according to which a refined definition of the technical fundamental and primary facts and consequently of the EDNC matrix to the CDNC matrix belonged in here. But the explanations in Section II.A.2.2.a greatly facilitate the reception of this refinement to the CDNC matrix. Hence this shift.

II.A.2 The 2^{nd} FSTP Facts Determination Stage and the DNC Matrixes—Exemplified by the '884 patent

The 2^{nd} FSTP facts determination stage identifies the two technical secondary facts of a PTR by two increasingly refined functionalities, its basic functionality and its inventive height functionality, whereby the second one significantly increases the indicative quality, i.e. the “indicative power”, of its technical secondary structured fact far above the one provided by the technical secondary basic fact hitherto known. Both functionalities are explained in Sections II.A.2.1 and II.A.2.2, reasoning on the element level resp. concept level.

### II.A.2.1 The Basic Functionality for Determining the Technical Secondary Basic Fact.

The purpose of the basic functionality is to make as simple as possible the determination of the classical technical secondary basic fact. It is provided by the two “FSTP tests” in the below two boxes (whereby their wordings are adapted to the '884 case)—which follow immediately from the Highest Courts' precedents¹³⁾. With the '884 PTR using the basic facts determination functionality is trivial¹⁰⁾, as both FSTP tests, together with the EDNC matrix, already show at the first glance the impossibility of the existence of any free not-changed actual anticipation-combination¹³⁾—even more a contradiction-free and element-wise not-changed actual anticipation-combination¹³⁾. ¹⁰ In the general case, using this basic functionality may require the complex analysis of the EDNC matrix's entries¹³⁾, making absolutely impossible the dependable execution of these FSTP tests by a human being without the automated FSTP.

Applying the FSTP tests to the '884 EDNC matrix shows (see the last paragraph in Section II.A.1.3): The

1^{st} FSTP test is, with anyone of the 16 document.i, at least 7-fold positive and the

2^{nd} FSTP test is, even with any free anticipation-combination¹³⁾ of the 16 document.i, at least 11-fold positive.

If holds for document.i, 1≦i≦16, and (at least) one element X, A≦X≦D, and (at least) one n=a, b,c, . . . :

“X.i).n not-discloses X).n” or more strictly: “X.i).n contradicts X).n”

for each pair of an X).n and an explicitly disclosed peer X.i).n¹¹⁾, ¹¹ Document.i may explicitly disclose more than 1 X.i).n, e.g. when disclosing several TT.p's. For simplicity, we here assume that there is only one such pair <X.i).n, X).n>—i.e. adapting the FSTP to the general case is trivial.

i.e.: if line.i in the EDNC matrix contains in its X).n-column an “N”, or more strictly a “C”, then this is the technical secondary basic fact indicating that document.i does not anticipate the '884-patent, as “document.i not-discloses '884-patent” resp. more strictly “document.i contradicts '884-patent”,

If holds for all document.i, 1≦i≦16, and (at least) 2 X).n-columns¹²⁾ ¹² One such X).n column potentially could be removed by a “sub patent law” cM of some X.i).n, while the removal by 2 cMs of 2 such X).n columns would with some probability not be “sub patent law”, whereby this probability increases as this value increases—with likely all Highest Courts.

“X.i).n not-discloses X).n” or more strictly: “X.i).n contradicts X).n”

for each pair of an X).n and an explicitly disclosed peer X.i).n¹¹⁾,

i.e.: if each line.i in the EDNC matrix contains for these 2 X).n-columns an “N”, or more strictly a “C”, then this is the technical secondary basic fact indicating that the '884-patent is nonobvious over the 16 document.i, this technical secondary basic fact being the more indicative the more such X).n-columns there are and “C” therein¹³⁾.

Thus, already these straight forward FSTP tests indicate clearly the nonobviousness of the '884 PTR (i.e. of the '884 TT.p over the '884 RS established by the above 16 document.i).

### II.A.2.2 The Inventive Height Functionality for Determining the Technical Secondary Structured Fact

Exceeding the indicative power concerning the nonobviousness of the '884 PTR's TT.p over its RS, as provided by the classic technical secondary basic fact, the FSTP analysis produces (on its 2^{nd} facts determination stage) by means of its inventive height determination functionality a substantial expansion of this technical secondary basic fact to the technical secondary structured fact—which provides much further reaching cognitive/indicative insights into this PTR's nonobviousness problem. This technical secondary structured fact is a pair <q, set of TT.p achievement structures=. While the value of q≧0 quantifies the “creative altitude¹⁵⁾” of the PTR's TT.p over the state of the art represented by RS, the set of one or several TT.p achievement structure(s) discloses all shortest ways of creativity from the semantic hull of RS to the TT.p. Thus, this/these TT.p achievement structure(s) explain(s) in detail, where exactly the value q≧0 comes from: Namely from the number q of independent thoughts needed to find the TT.p starting from the semantic hull of RS, i.e. the creative altitude is measured in the unit of measurement as implied by the German Highest Courts' precedents.

As mentioned above already, for a PTR, the determining of the value of its q can take place simply (namely on its attributes' amorphous element level but yet considering independent¹⁷⁾ cMs only, as practised in Section II.A.1.3) or in a more subtle way and thus coming closer to reality (namely on its attributes' concept level, which recognizes concepts as refining the notion of an amorphous element level). Both values are lower limits for the true number “Q” of independent thoughts at least to be created in reality by an inventor of the PTR's TT.p in order to find it starting from the state of the art represented by its RS—whereby this potentially much larger number Q would not be accurately determinable for most real world PTR's. ¹⁷ There could be a wish to complement this “outwardly acting” meaning of independence of a cM-inventing thought (asking whether it impacts any other X.i).n) by an “inwardly acting” meaning of its independence. Such an inwardly acting meaning of a cM-inventing thought's independence would not refer to a potential impact of its change to another attribute X′.i).n′, but would assess that this thought has “materially” nothing to do with another cM-inventing thought—thus exceeding the a priori precondition that cM-inventing thoughts are different from each other, even if applied to different X.i).n's. Such a hunch of a notion derived from the beautiful wish of independence of cM-inventing thoughts from one another appears hardly rationalizable, as eventually any thought is somehow depending an any other one—the rationalizableness of such a requirement to be met by a thought of “nothing having to do with another thought” is actually set no limits. I.e.: It is unreasonable to restrict the important notion of “independence” of a cM-inventing thought by esoteric demands (but see Section III). On the other hand it is clear that the above “outwardly acting” meaning of the notion of independence of a cM-inventing thought is indispensable, if it is a matter of indicating that two different such cM-inventing thoughts together justify their joint changes to be worth patenting as a whole—thus leveraging on the German BGH's precedent, according to which two independent change-inventing thoughts indicate that there is a basis for the patentability of their joint invention. This indication were questionable—as explicitly stated by the BGH—if this whole change were potentially caused also by only one of these two different thoughts, as they were not independent.

The creative heights q of the '884 PTR—they are different depending on which of both levels of resolution they are determined—together with their respective achievement structures will be explained in Sections II.A.2.2.a and II.A.2.2.b on both above “FSTP analysis levels”.

Upfront three contextual issues are worthwhile to be stated:
The FSTP's inventive height determination functionality may demonstrate in detail an in this context extremely important phenomenon: It namely may show that an in hindsight allegedly obvious solution of a technical problem over prior art (i.e. a TT.p over its RS), may in reality at the time of its invention have been anything but obvious for the skilled person. This FSTP may show this by rationalizing by means of its secondary technical structured fact that this TT.p in truth then may have needed a complex bunch of technical modifications of independent features of the then prior art—thus that it then was totally unrecognizable by him, being caught in this prior art's of thinking, as these many technical modifications consequently were “on the outside inconspicuous, technically unusual, seemingly unrelated to each other, substantially effective only by their complementation, anyone of them being indispensable”. I.e.: These technical modifications of the then prior art must have been thought through several times in several novel and independent ways, in order to get at this TT.p starting from this prior art RS. The below '884 rationalisation by the FSTP of the term “technically obvious” shows how deceptive it actually is.
Despite the impressiveness and persuasiveness of the idea of a “secondary technical structured fact”, as it will become evident subsequently, it is absolutely impossible to determine it without the completeness and precision guaranteeing working of the FSTP—and in particular not by means using only a natural language. Any natural language meets many human requirements but not those of a complete and precise facts determination in a clearly defined but very complex legal case (such as a technical (non)triviality/(non)obviousness problem)¹⁴⁾.
The FSTP determines the inventive height¹⁵⁾ q of a TT.p over some given prior art RS as the minimal number of independent thoughts indispensably required for reaching the former starting from the latter. The FSTP thereby determines this value of q by repeatedly applying the ground laying analysis of the German BGH concerning “technical minimum facts” indicating an inventive step. I.e.: The FSTP determines this value by ascertaining how many conceptually independent modifications have to be unavoidably undertaken to this prior art in order to reduce “to 0” its “structural distance” from this TT.p—i.e. which (and hence how many) conceptually independent modifications of the state of the art are minimally necessary so that it discloses the latter by means of a then actual anticipation-combination over it.
   II.A.2.2.a: The Element Level Determining the value of the inventive height '884 q on the element level must start from document.6, as it discloses reaching out furthest towards the '884 TT.p, starting from the '884 RS (see the '884 EDNC matrix): An anticipation-combination using the disclosures/attributes B.6).a and C.6).a/C.6).d from document.6 already anticipates/discloses the 3 peer element attributes B).a and C).a/C).d of the '884 TT.p—and none of the 15 remaining documents.i discloses more '884 element attributes.

Of the remaining 12 '884 attributes not disclosed by document.6, one could pass

one as being disclosed by the peer attribute per “sub patent law cM” in one of the 16 documents.i, and

another one per C.5).e—ignoring the element integrity requirement by footnote 13.

Thus, at least 10 further independent cMs of some document.i disclosures (i.e.: of their X.i).n's) “must be invented” in order to be able to achieve the '884 TT.p by an anticipation-combination over RS—the latter then being made up from these 4+1 (unchanged)+1 (sub-patent-law changed)+9 (changed by at least one invented cM each) X.i).n's.

Two observations are important here:
Several attributes X.i).n are made up from references to several different concept values, thus making them disclose their resp. peer X).n may require inventing several independent cMs for them, i.e. independent creative ideas for them (Note: During the invention process of the TT.p it and its cMs to the RS are not known yet!).
A formal analysis of all disclosures/attributes of all 16 documents.i¹⁶⁾ shows that it is logically impossible, that there is a single thought of changing some X.i).n by a cM modifying the value of some concept such that it discloses its peer X).n, which would also cause a change of a second X′.i).n′ so that it discloses its peer X′).n′,
in addition—as the X.i).n's are referring mostly to quite different concepts or a different concept value (all not affected by this cM alias its underlying creative thought). Such a creative cM-inventing thought (and the cM performing its change of some X.i).n), is (are) therefore called “independent”¹⁷⁾. ¹⁶ This formal analysis is not presented here because the following elaborations make it superfluous:

Hence, the required 10 resp. 11 changes of X.i).n's—when ignoring resp. meeting the “element integrity” requirement of footnote 13—need inventing at least 10 resp. 11 independent different creative thoughts. I.e., using the inventive height determination functionality of the FSTP in this “simple” way (i.e. on the element level, assuming 1 cM of an X.i).n suffices for making it disclose X).n), it determines the value of the '884 q to be =10 resp.=11. Note that the value of the '884 q were =∞, if also the contradictionless requirement of footnote 13 were to be met.

II.A.2.2.b: The Concept Level Determining the value of the inventive height fact, '884 q, on the more subtle concept level, again with 1 “sub-patent-law cM” granted (see above), delivers that the so determined value of '884 q is either=12 or =17 (ignoring resp. meeting the above “element-integrity” requirement, and again=∞ if also the above contradiction-less requirement were to be met).

First—before the working/use of the FSTP's inventive height determination functionality on the concept level is explained in detail—the notions and reasons are explained for this better approximation of the real number '884 Q of independent inventive thoughts actually required (see the preceding paragraphs).

The “concept attribute” level of abstraction (of “mental resolution”), for short: “concept” level, notionally lies below the “element attribute” level of abstraction (of “mental resolution”), for short “element” level. The “technical Graham facts” of the US patent jurisdiction lie above this element level of abstraction/resolution—so that there is a stack of 3 notional abstraction/resolution levels to be distinguished from each other. Whereas on the Graham level independent inventive thoughts (i.e. their conceptual modifications cMs) cannot be identified at all, independent thoughts and their cMs become visible on the element level, however they still cannot be simply grasped individually (as element attributes may comprise several concepts, see Section II.A.2.2.a)—whereas also this is possible on the concept level, as shown next.

The (semi)automatic “conceptualization” capability of the FSTP refines its analytic capabilities. The conceptualization of a problem is an IT procedure established as indispensable for decades already in modelling a “real world complex”—by developing e.g. a “semantic network” for it—enabling its structured mapping into a data base. Here it is a prerequisite of the FSTP's determination of a PTR's technical secondary structured fact and requires proving the independence¹⁸⁾ of these concepts, as to the German BGH's precedents (see¹⁷⁾). ¹⁸ Concepts are representatives—on some predetermined notional level, e.g. provided by the functionalities of anticipation-combinations over RS—of simply describable issues, e.g. which do or do not exist, i.e. evaluate to Y (yes) or N (no), and then are called “binary concepts”. A concept in a TT may change its value over time (and/or over other concept values). The elements' attributes, X).n and X.i).n, are logical expressions of concepts only (and logic and/or concept value operators, see Section I.A). A change of a concept value in an attribute X.i).n is called its “conceptual modification, cM”. A cM in an attribute of a set of attributes (e.g. all X.i).n's of some document.i) is called “independent”¹⁷⁾, if it has no effect on another one of the attributes of this set. The cM-inventing thought creating this cM is likewise called independent. In a PTR a concept as a whole is called independent, if all its cMs (with respect to all its X.i).n's) are independent. In particular: Two different independent cMs of one attribute are created by two independent cM-inventing thoughts. In what follows, the above 15 '884 X).n's are replaced—due to the FSTP conceptualization of the '884 PTR—by C.j's, 1<=j<=28, and any actual anticipation-combination¹³⁾ on this concept level now has to achieve/disclose these 28 C.j's. Here only 4 X).n's are replaced by logical sums of the attributes C.1-C.11 and C.23-C.28, of the other 11 X).n's each is replaced by a single one of the concepts C.12-C.22 (as shown below). For example: The element attribute D).b (for its definition see Section II.B) is replaced on this concept level by the concept attribute sum: “C.23=Y and C.24=Y”.

| | | | | |
|---|---|---|---|---|
| A).a: | C.1: | “PSN known and both switches have access thereto”, | C.2 | “Switch position totally outside or inside the networks”, |
| | C.3: | “comm. connection individual management known”, | C.4: | “Second switch known”, |
| | C.5: | “first change always from PSN to LSN”, | C.6: | “Anytime signal known and recognizable at any time”, |
| | C.7: | “Anytime change to PSN possible”, | | |
| A).b | C.8: | “First switch internal change trigger known”, | C.9: | “Real-time quality of this DT known and monitored”, |
| | C.10: | “Change already with potential quality loss”, | C.11: | “Change of considered comm. connection only”, |
| A).c: | C.12: | “Change possible with start of PSN data transfer”, | | |
| A).d: | C.13: | “Switch has interface for connecting to it of at least one ISDN or | | |
| | | analog or mobile telephone”, | | |
| A).e: | C.14: | “DT start by PSN immediately with telephone call connection | | |
| | | establishment”, | | |
| A).f: | C.15: | “PSN and LSN access of switches separated”, | | |
| B).a: | C.16: | “PSN is not the ISDN packet switching service”, | | |
| C).a: | C.17: | “PSN is not needed for establishing a LSN connection”, | | |
| C).b: | C.18: | “User-DT partially free of retransmission”, | | |
| C).c: | C.19: | “DT times less than 0.5 seconds”, | | |
| C).d: | C.20: | “Switch needs no consensus for starting sending over the PSN | | |
| | | telephone-call data”, | | |
| C).e: | C.21: | “Switch needs no consensus for changing-over to PSN at signal | | |
| | | detection”, | | |
| D).a: | C.22: | “Signal has precisely one of the 3 ‘884 events monitored and is released | | |
| | | at any occurrence of these 3 events”, | | |
| D).b: | C.23: | “Signal has change effect iff according to ‘884 specification”, | C.24: | “Signal cannot be rejected by anyone or anything”, |
| D).c: | C.25: | “Signal trigger possible with start of the PSN DT”, | C.26: | “Signal affects only comm. connection considered”, |
| | C.27: | “Signal has no confirmation requirement”, | C.28: | “Signal can be transparent to both switch users”. |

A change of a C.j value by a cM (in one of the X).ns) causes no change of another C.j and hence of none of the other 14 X).n's—as none of them contains the former C.j at all. Thus, the 28 C.j's are independent with respect to the X).n attributes. This independence also applies for all 15 X.i).n's from any anticipation-combination—due to the relevance only of their peer projections onto the respective C.j, and therefore for the same reasons as with the 15 X).ns. Finally, 2 remarks concerning the just exemplified principle of the FSTP-conceptualizing a TT.p over its RS for analyzing this PTR by means of the FSTP's inventive height determination functionality on the concept level: These 28 '884 concepts do not follow solely from the limitations analysis of the '884 claims wording, but from the 17 documents' disclosures concerning their TT.p and TT.i's—as outlined in Section I. Evidently several of these 24 C.j can be broken down into more elementary independent conceptual attributes (e.g. C.1), and there are also additional concepts of the TT.p (in particular within all 4 element attributes X).n's), which both technically clearly differentiate the latter from the 16 TT.i's and hence from the '884 RS's anticipation-combinations—so that even significantly higher values can be determined for '884 q on thus refined concept levels than the above values on this concept level.

In a PTR, taking its TT.p's X).n's as concepts may be impossible, as these are too complex (as is the case with the '884 PTR) for representing a clearly graspable “inventive thought” each being provable as independent. Therefore any X).n is replaced by one or a logical sum of several concepts that are as simple as to allow proving their independence. This replacement—normally the concepts may be defined such as to only marginally relax the limitations of the X).n's—is called the “FSTP conceptualization” of the PTR, e.g.¹⁸⁾ for the '884 PTR.

The FSTP conceptualization is an instrument for forensically testing the semantic height of a PTR's TT.p:
Figuratively speaking, the FSTP forces its user to mentally identify specific fundamental notional building blocks of its TT.p and their peer notional building blocks in the TT.i's (disclosed in the document i's or addible to them by contradictionless imagination¹³⁾), whereby the letters ought to differ from the formers by simple features, only. The formers then are suitable as FSTP concepts and may establish a concept level for the PTR¹⁸⁾.
Logically speaking, the so identified specific fundamental notional building blocks are “logical probes” sensing/stating the various conceptual deviations of the TT.p's functionality (as conceptually represented by these probes) from the functionality of the hull of RS¹³⁾, whereby the removal of a particular deviation—caused by the peer X.i).n's in RS of some X).n's, more precisely: by a concept a X).n uses and no peer X.i).n knows or uses the same way—may be achieved by a cM of one of these X.i).n's (causing this deviation). When the TT.p was invented this cM must indispensably have been created by a corresponding independent thought for getting from the RS to the TT.p (whether the inventor became aware of this/his thought or not).

But note that besides these conceptual other functional deviations may (but need not necessarily) exist between the TT.p and the hull of the RS, the overcoming of which then may require additional creative thoughts—which were not counted when determining the former's semantic height over the latter by means of the TT.p's FSTP conceptualisation (see Section III).

The FSTP conceptualization of a PTR is only a preparatory step for determining its minimal value of q on this concept level. I.e.: On the basis of any FSTP conceptualization whatsoever, the FSTP may determine the respective minimal number q of such independent concepts in some X.i).n's of an anticipation-combination over RS—represented on this concept level—to be changed by q cMs in order to make it achieve¹³⁾ TT.p. The X).n's thus to be made disclosed/anticipated (each by at least one respective cM of some peer X.i).n) remain the same for all anticipation-combinations over RS, while their peer X.i).n's and therein the concepts to be modified by cMs may change for different anticipation-combinations and the more for different FSTP conceptualizations. By refining the FSTP conceptualization of a PTR its value of q may increase or not.

The FSTP conceptualization may be performed by the FSTP fully automatically or need the support by the FSTP's user. In an attempt to indicate the nonobviousness of a TT.p over some RS the FSTP conceptualization would from the PTR's fundamental facts as many independent concepts as possible in order to maximize the value of q. But the FSTP does not guarantee that there is no transformation of a PTR's presentation according Section I.D and its fundamental facts, which would allow a smaller value of q—whereby the proof of finding this transformation of the PTR's presentation without other creative thoughts for finding it is left to the attacker of a patent's TT.p.

For the '884 PTR, its FSTP conceptualization would automatically derive—directed by its user and thus identifying at least the concepts of footnote 18—from the '884 EDNC matrix the '884 CDNC matrix shown below. To this end it simply breaks down, on its 1^{st} facts determination stage, 4 X).n columns of the EDNC matrix (as explained in the subsequent paragraphs and in footnote 18). On its 2^{nd} such facts determination stage the FSTP derives from this '884 CDNC matrix the above given values of '884 q on this concept level, i.e. an improved lower boundary for the value of the aforementioned '884 Q.

In detail: There are 11 '884 element attributes (and their columns in the '884 CDNC matrix) which are not refined (just reworded as binary concept attributes) by the concept attributes of footnote 18. The CDNC matrix thus follows from the EDNC matrix by breaking down the 4 “concept analysis requiring” columns for the element attributes A).a, A).b, D).b and D).c. E.g. also D).a may be broken down—but this is skipped here for simplicity. References to several C.j's in one X).n are highlighted in the '884 CDNC matrix by their very bold horizontal lines.

What the CDNC relation is between the 17 substantially new “document.i-concept.j-attributes, X.i).n>C.j” per document.i and the C.1-C.11 and C.23-C.28 replacing the peer to “X).n>C.j”—whereby the concept attribute X.i).n>C.j is defined as the “projection of document i's element-attribute X.i).n onto concept C.j peer to the projection of the '884 element-attribute X).n onto concept C.j”, this analogy being PTR depending—would be determined automatically by the FSTP or by its user. For the '884 PTR these relations are trivial and determined by the author as shown in the CDNC matrix. As the other 11 X).n>C.j are =C.j, the CDNC relation between X.i).n>C.j and X).n>C.j is the same as in the EDNC matrix.

In any actual anticipation-combination of TT.p on the concept level, any C.j reference therein is changed by a cM—if necessary—so that it discloses the peer TT.p value. And the minimum number of such cMs over all actual anticipation-combinations of TT.p is the minimum number of the independent cM-inventing thoughts, which must unavoidably be applied to the RS, in order to get from it to the TT.p. I.e.: In order to find the TT.p—starting from the state of the art. RS—at least this minimum number a of independent cM-inventing thoughts is reauired.

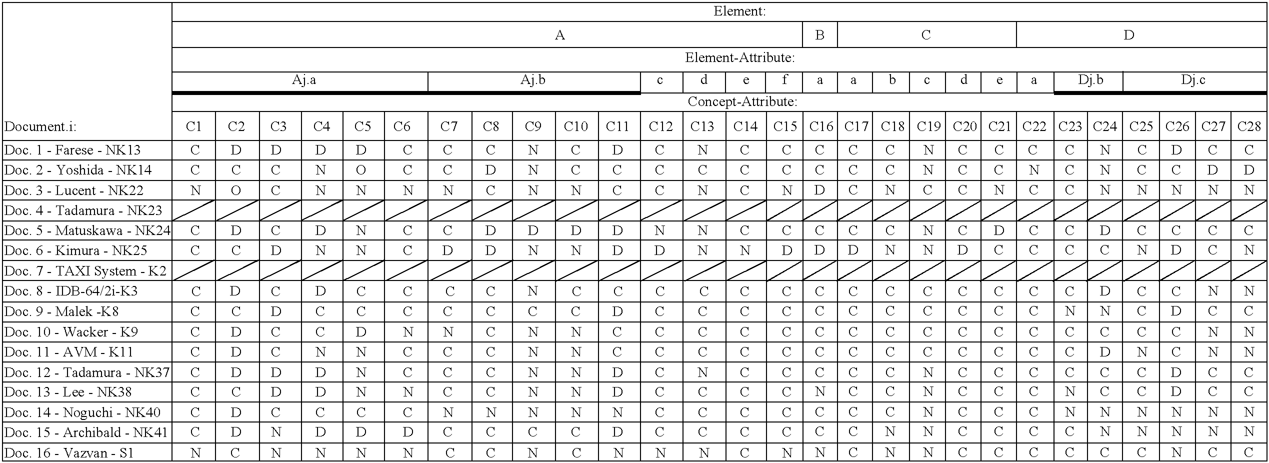

If meeting the “element integrity” requirement of footnote 13, the number '884 q of the independent cM-inventing thoughts, determined on the concept level, amounts to 17, as the CDNC matrix shows by the 4 lightly shaded element.i blocks of document.1, document.6 and document.2 for the elements A, B, C, D: Of the 28 concept attributes of the '884 TT.p 10 are disclosed by these shaded element.i blocks, and 1 can pass as disclosed by a sub-patent-law cM. Otherwise (i.e. ignoring the “element integrity” requirement), the value of this '884 q would naturally be lower, namely=12, as shown by the dark shaded 5 boxes for X.i).n>C.j, which then can be combined with the shaded element.i blocks.

To finally characterize the inventive height functionalities in Sections II.A.2.2.a and II.A.2.2.b: Starting from their two different levels of logical resolution of the PTR's technical fundamental facts and their resp. RS hulls¹³⁾, both functionalities determine under various possible conditions¹³⁾—eventually by the FSTP tests—the resp.

lowest creativity q indispensably required for achieving the TT.p over this combinatorial hull of prior art, and

all q-anticipation-combinations of this hull and for each of them all shortest paths of creativity/ingenuity to TT.p.

II.B Determining the '884 TT.g's Attributes on the Element Level from the '884 Disclosures

As announced by the beginning of Section II.A, here the 15 attributes X).n of the 4'884 elements of the '884 TT.p are determined by identifying their natural language/graphic '884 disclosures—in the specification, in the drawings and in the claims of the '884 patent—and translating them into these precise '884 attributes. For reasons of efficiency subsequently this identification of the natural language/graphic '884 disclosures takes place only per references, their uses of the individual independent concepts are not commented, and the trivial intermediary stages of these translations of the disclosures into the 15 '884 formal attributes are left out as well. All derivations/definitions of the 15 '884 formal attributes and their most important implications are presented by means of a uniform scheme, which consists of recurring sentence fragments and acronyms supposedly to mean:
The formal '884 attributes (in bold) are followed by the references to the '884 disclosures justifying them.
By “CsoX).n . . . ” (Cso=Consequence of)—this abbreviation stands for “an X.i).n not-discloses X).n or even contradicts X).n”, which Section II.C.i determines—for X).n at least one condition alias X.i).n is given, with the disclosure of which in document.i at least the first of these two relations holds.
The “II.C.i” line identifies document i's disclosing such X.i).n's, which is likewise ascertained in Section II.C.i.

As to the BGH precedent, the '884 TT.p is to be used for the interpretation of the '884 claims, which implies that for all 4'884 elements the limitations apply that are indispensable for achieving the real-time quality of the data transfer required by Internet telephony (as also disclosed by the '884 specification), which are reflected by 15 formal attributes X).n.
A).a This '884 “switch” attribute states: “The first switch in total lies in front <or behind, which is ignored here> of its subscriber lines, and knows the data transfer in a considered communications connection to a second switch, and carries out the first change-over always from a packet switching network to a line switching network, but if and only if an '884 signal is detected and a line-switching connection is available or established, whereby this detection may occur anytime.”
   The '884 “switch” attribute A).a is disclosed for example in claims 1 and 2 of the '884 patent and the '884 signal in col. 9:23-41.
   CsoA).a, if in document.i “a second switch”, “a data transfer in a communications connection considered”, “its change-over iff an '884 signal is detected” and/or “a packet switching network” is not-disclosed or contradicted (=“ndoc”).
   II.C.i shows: CsoA).a holds for all document.i, 1≦i≦16.
A).b “In the event of a threatening loss of real time quality of this data transfer the first switch automatically triggers for just it the change-over from packet-switching to line-switching transfer.”
   A).b is disclosed e.g. in claim 8 and in the '884 specification in col. 9:23-52, see Section II.A.1.2.
   CsoA).b, if in document.i is ndoc a change triggered by the communications connection considered if it fulfils the condition of Section II.A.1.2, and/or exceeding a certain noise level at the 2^{nd} switch.
   II.C.i shows: CsoA).b holds for all document.i, 1≦i≦16.
A).c “The first switch is capable of changing-over right with the beginning of the packet-switched data transfer of its considered communications connection, and with just this data transfer, and without interrupting the communications connection, and only triggered by it alone.”
   A).c is disclosed in the '884 claims 1, 2, 8, 10, 11 as well as e.g. in cols. 3:15-19, 3:57-62, 7:18-26, 9:23-52 and 11:33-39 (FIG. 5 a).
   CsoA).c, if in document.i is ndoc: a packet switching network, and/or that this change-over may take place right with the beginning of its packet-switched data transfer and/or only with this data transfer and/or without interrupting the communications connection and/or only triggered by this alone.
   II.C.i shows: CsoA).c holds for all document.i, 1≦i≦16.
A).d: “The first switch has an interface for connecting at least 1 ISDN or analogue or mobile telephone.”
   A).d is disclosed e.g. in FIGS. 1 and 4, as well as e.g. in cols. 7:40-47, 8:23-30.
   CsoA) d, if in document.i is ndoc: a connection possibility of such a telephone.
   II.C.i shows: CsoA).d holds for all document.i, 1≦i≦16.
A).e: “The first switch always starts the considered packet-switched data transfer by starting a telephone call set-up or generally establishing a real-time communications connection¹⁹⁾.”¹⁹ The initial data transfer in an ISDN for establishing a network connection—which need not be established in a packet switching network, as there network connections permanently exist between all DTE's actually connected to it—must not be confused with starting a telephone call or a real-time communications connection: It does not yet belong to a telephone call or a real-time communications connection, i.e. is not yet starting a “telephone call set-up” indispensable in any call via a multi-party/multipurpose network such as the Internet. The same applies, if the initial packet-switched data transfer in the communications connection considered establishes a V.120 connection first, or gains access to a network first. See also footnote 6.
   A).e is disclosed by col. 9:8-10: this disclosure says that an '884 data transfer starts by packet switching. I.e.: There is no packet-switched data transfer for a telephone call prior to starting its establishment, i.e. it starts right with the call set-up or establishment of the communications connection.
   CsoA).e, if document.i has to start the data transfer for a call with something different, e.g. either with first establishing a network connection or a V.120 connection or a request for access ¹⁹⁾ or is ndoc: a telephone call and/or a packet switching network.
   II.C.i shows: CsoA).e holds for all document.i, 1≦i≦16.
A).f: “The 1^{st} switch—if it is not part of a network, see A).a above—has permanent access to the line-switching network and a separate access to the packet-switching network”.
   A).f is disclosed by '884 claims 1 and 2—which both provide for their switches permanent access to a line-switching network and to a packet-switching network, by a dialled switched line over this line switching-network in claim 1 and by a permanent line in claim 2—as well as the description of FIG. 1 in col. 7:49-52 as well as the description of FIG. 4 in col. 8:34-52, 9:42-52 (of the IP-switch 72 and of the line-switching device 73, respectively, which both show two separate lines for their two network accesses).
   CsoA).f, if document.i discloses only one network access for accessing both switching functionalities, as in the case of an ISDN and other “integrated” networks, or is ndoc: any access details at all and/or a packet-switching network.
   II.C.i shows: CsoA).f holds for all document.i, 1≦i≦16.
B).a: “The packet switching network is disclosed, not only the packet switching function of an ISDN.”
   B).a is obviously disclosed as regards its 1^{st} part, and as regards its 2^{nd} part it is disclosed 6 times in the '884 patent, as (1)-(6) show independently of one another:
   (1) The '884 patent limits ISDNs as being used as line switching networks only, by explicitly stating:
      “If an ISDN network exists, an ISDN-B channel is used as the data channel” (col. 4:61-62), and
      “Data packets are thereby sent through the B channel”(col. 4:62-63).
   (2) The classification of networks as packet-switching or line-switching is shown in the '884 FIGS. 1-4: In the '884 TT.p, “PSTN/POTS” is a synonym to “ISDN”. Hence, as the term PSTN/POTS always stands for a line-switching network, this also applies for the term ISDN.
   (3) Col. 9:8-10 is explicit: The 1^{st} switch's basic state provides that initially “data is sent into the Internet through the IP switch 72”—and thus excludes the line switching device 73 from use in the packet-switched transfer, as were necessary for using an ISDN's packet-switching function as packet-switching network.
   (4) Claims 1 and 2 clearly assume that their two switches can change-over to the line-switching network with their considered packed-switched data transfer, even with a total failure of the packet-switching network—which is impossible in an ISDN. In the event of a total failure of a thus understood “ISDN packet-switching network” the limitations 1.e) resp. 2.d) in both claims cannot be realized, as the ISDN packet-switching functionality were required for this—namely for transferring the ISDN signalling command SETUP by this packet-switching functionality of the ISDN, see col. 9:46-47—which were not available after this event.
   (5) Feature a) of claim 1 is technically and cost-wise complete nonsense, if an ISDN is considered as the invention's line-switching network (to which the first switch has access) and its packet-switching function as its packet-switching network: The first switch then namely has already, with its ISDN access, always also access to this hypothetical packet-switching network. Then establishing a connection over the ISDN—according to limitation a)—to this own access point of the hypothetical packet-switching network would technically be completely absurd, just as establishing such a connection over the ISDN to a remote access point of the hypothetical “ISDN-packet-switching network”: In both cases—if they were technically realizable at all, which then were pathological cases—establishing such a connection would bring no advantage but unavoidably additional cost (which is to be lowered by using the packet-switching network).
   (6) The international standardizations body solely responsible for ISDNs, the ITU-T (=International Transportation Union—Telecommunications) and their pertinent standard, the “Recommendation H.323”, clearly defines an ISDN as a line-switching network (as a “switched circuit network—SCN)”). I.e., at the '884 priority date, the ITU-T had already clarified that an ISDN is a line switching network, thus negatively deciding the question (which was controversially debated by some only in the early 80's), whether an ISDN's packet-switching function might allow to call it a packet-switching network.
      CsoB).a, if document.i only discloses an ISDN or another integrated network, or does not disclose a packet-switching network at all.
      II.C.i shows: CsoB).a holds for all document.i with i≠3 or 6.
         C).a: “The establishment of a line-switched connection is independent of the packet-switching network.”
   C).a is disclosed in the '884 specification by the line switching device 73, col. 8:47-50. It comprises a digital coupling 731, as is required for switching telephone channels through a line-switching network, and establishes the line-switching connection for a change either as “new” ISDN/PSTN connection or on an existing ISDN/PSTN connection by multiplexing/demultiplexing it, col. 10:56-63, 11:18-23. In both cases it has no contact with the packet-switching network. See also (4) in the above B).a.
   CsoC).a, if in document.i a total breakdown of the hypothetical packet-switching network makes the establishment of a line-switching connection impossible (as in the ISDN or MUMTS cases), or if this is by design not possible in spite of the problem-free functioning of the packet switching network.
   II.C.i shows: CsoC).a holds for all document.i with i≠6.
      C).b: “At least a part of the user data transfer occurs retransmission-free.”
   C).b is disclosed e.g. in col. 3:61-62 by stating the '884 data transfer were suitable for Internet telephony, whereby cols. 7:1 and 8:39 disclose the use of the UDP to this end. Meeting this requirement avoids that a transferred speech signal, containing residual bit errors, is retransmitted—thus additionally garbling it, in particular if it is compressed, cols. 2:9-10, 8:39-46.
   CsoC).b, if in document.i each user-data transfer takes place over the packet switching network by X.25 or TCP or another residual bit errors and/or packet loss avoidance protocol (because these unavoidable cases always “retransmit” the packets involved and thus make the data transfer unsuitable for telephony)—which holds e.g. if the UDP is not disclosed for an Internet data transfer (but just TCP), or while only the ISDN-D channel is used for user data, or only “data networks” are envisaged (as these always use such “all residual errors avoiding” protocols).
   II.C.i shows: CsoC).b holds for all document.i with 1≦i≦16.
      C).c: “The time delays in the data transfer between the switches are ≦0.5 seconds”
   C).c is disclosed in col. 2:10 and 7:11-12.
   CsoC).c, if in document.i is ndoc: this data transfer or its upper limit of at most 0.5 sec time delay.
   II.C.i shows: CsoC).c holds for all document.i with 1≦i≦16.
C).d & C).e: “No condition requires the 1^{st} switch to achieve a consensus via the packet-switching network with the network or the second switch or its user
   C).d initially for starting sending telephone-call data or
   C).e anytime for starting changing-over to line-switching data transfer, if the '884 signal is present.”
   C).d and C).e are disclosed by claims 1 and 2, which both enable the first switch to unilaterally (i.e. without achieving via the packet-switching network any kind of consensus) start at any time its packet-switching data transfer to the second switch of telephone call specific data to the latter and/or, if only an '884 signal is present, its change-over to line-switched data transfer.
   CSoC.i).d & C.i).e, if in document.i, prior to the start of the telephone call, the first switch has to achieve a consensus via the packet-switching network with the network or with the second switch or its user—as is the case with using the packet-switching function of an ISDN, or with the initial establishment of a V.120 connection, or with the initial request of access to a mobile packet-switching network.
   II.C.i shows: CsoC.i).d & C.i).e holds for all document.i with i≠6 and ≠5.
      D).a: “An '884 signal may only have and always has at least 1 of the 3 alternative origins/causes: It is
   either sent to the first switch by
      another switch, triggered by a network management, or
      an end terminal of the considered communications connection, triggered by its user,
   or automatically generated by the first switch and by only this data transfer²⁰⁾ ²⁰ See Section II.A.1.2
   otherwise it is no '884 signal.”
   D).a is disclosed as discussed in Section II.A.1.2.
   CsoD).a if in document.i a signal has another than or cannot have one of these origins/causes. As this disclosure represents an exhaustive positive list of pairs <place of origin, cause of generation> capable of generating an '884 signal—consequently any pair <place of origin=host computer, cause of generation=application> is excluded from generating an '884 signal.
   II.C.i shows: CsoD).a holds for all documents.i, 1≦i≦16.
D).b: “A signal initiates a change-over if and only if it has the D).a property, and then never is in vain because of the non-accessibility of a line-switching network—otherwise it is no '884 signal.”
   D).b is disclosed e.g. in claims 1 and 2 (see Section II.A.2).
   CsoD).b if in document.i the signal is triggered either by an application/host or by the first switch itself but not according to Section II.A.1.2 and/or if it can be rejected by anyone or anything.
   II.C.i shows: CsoD).b holds for all documents.i, 1≦i≦16.
D).c: “A '884 signal can be generated with the start of the packet-switching data transfer to the second switch (in particular: prior to sending out to this network anything to the latter, by the first switch), and is, at least if generated by a user or the first switch, limited in its effectiveness to the communications connection considered, and needs nobody's confirmation for becoming effective, and need not be brought to the knowledge of a user—otherwise it is no '884 signal.”
   D).c is disclosed in claims 1 and 2 (see Section II.A.2).
   CsoD).c if in document.i the change-over signal cannot be generated by the first switch immediately after starting the first packet-switching data transfer to the second switch (which means: even prior to its sending out anything to the latter to this network), or cannot be limited—if generated by a user or the first switch—in its effectiveness to the data transfer only of the communications connection considered, or requires somebody's confirmation for becoming effective, or must be brought to the knowledge of a user.
   II.C.i shows: CsoD).c holds for all documents.i, 1≦i≦16.

Note that prior to having invented the '884 TT.p none of these 15 attributes was known, i.e. that they represent the '884 invention. This probably provides a feeling/insight why it is not obvious at all.

But more important is to understand that—as these 15 attributes then were not known—it then also was impossible to define, which properties of the prior art TT.i's had to be changed how by how many cMs (as leveraged on in Section II.A.2.2) and then to be combined in order to find an actual anticipation-combination for the '884 TT.p. Prior to the '884 invention an exhaustive search for it would have required an infinite number of tests, i.e. was impossible.

### II.C The EDNC Relation for the '884 PTR—Determined “By Hand”

The following Sections II.C.i determine “by hand” (i.e. by the author, not the FSTP) on the element level for each of the 16 documents.i and for any of its relevant natural language disclosures—i.e. for this document i's 15 X.i).n's being peer to the resp. X).n's—whether it not-discloses or even contradicts X).n (which determines the EDNC matrix entries N or C, the D entries being the trivial alternatives). Determining the CDNC matrix works the same way, but is even more elaborate, and therefore is omitted here for brevity.

Below these N/C statements are underlined, followed by their brief justifications—unless these are trivial. The abbreviations/acronyms introduced at the beginning of Section II.B apply also below, of which the acronym “see CsoX).n” is permanently used.

### II.C.1 FARESE—Document.1/NK13

Farese discloses a dynamic changing of the ISDN “access path”—between a USER TERMINAL 10 (=alleged first switch) via the ISDN SWITCH 35 and the HOST SITE 80 (alleged second switch), FIGS. 4 and 5—between a line-switched B-channel and a packet-switching D-channel connection during a “host session” running over this access path, controlled by instructions of the “host computer” in this session, in order to correspond to the respective “communication needs of the session”, col. 6:61-7:10. Its single network is an ISDN.

From the document.1 disclosures follow the 15 “not-discloses”/“contradicts” relations:

| | | |
|---|---|---|
| A.1).a not-discloses A).a: | see CsoA).a and (CsoD).a or CsoD).b | (N) |
| | or CsoD).c) | |
| A.1).b not-discloses A).b: | see CsoA).b | (N) |
| A.1).c contradicts A).c: | Farese discloses that his terminal 10 | (C) |
| | can only change during an already | |
| | established host session, i.e. not | |
| | while establishing it, FIGS. 4 and 6 | |
| | or their brief descriptions in col. | |
| | 8:66-9:2 and 9: 7-10. | |
| A.1).d not-discloses A).d: | Terminal 10 discloses no telephone | (N) |
| | connectability. | |
| A.1).e contradicts A).e: | see CsoA).b | (C) |
| A.1).f contradicts A).f: | see CsoA).f | (C) |
| B.1).a contradicts B).a: | see CsoB).a | (C) |
| C.1).a contradicts C).a: | see CsoC).a | (C) |
| C.1).b contradicts C).b | see CsoC).b | (C) |
| C.1).c not-discloses C).c: | see CsoC).c | (N) |
| C.1).d contradicts C).d: | see CsoC).d | (C) |
| C.1).e contradicts C).e: | see CsoC).e, since setting up a line- | (C) |
| | switching “access path” depends on | |
| | the consensus of the second switch, | |
| | to use the V.120 protocol (further), | |
| | see FIG. 6, lines 607-685 | |
| D.1).a contradicts D).a: | see CsoD).a | (C) |
| D.1).b contradicts D).b: | see CsoC).b | (C) |
| D.1).c contradicts D).c: | see CsoC).c | (C) |

### II.C.2 YOSHIDA—Document.2/NK14

Yoshida discloses a “system for access to an ISDN from a packet data handling system”, co1.1:11-12—i.e. an “ISDN terminal adapter” (comprising all devices in FIG. 1 between the “LAN NT 16” and the “ISDN NT13”)—wherein the former system achieves that the transfer of data packets from the latter system “to a called party”, as a reaction to a “channel change signal” (caused by the increase of the data packet rate generated by the latter system), changes from using a packet-switching “virtual circuit” to a line-switched “virtual circuit” of an ISDN, without thereby interrupting the transfer of data packets, col. 2:9-14, ABSTRACT. Its sole network: an ISDN.

From the document.2 disclosures follow the 15 “non-discloses”/“contradicts” relations:

| | | |
|---|---|---|
| A.2).a not-discloses A).a: | see CsoA).a. | (N) |
| A.2).b not-discloses A).b: | see CsoA).b. | (N) |
| A.2).c contradicts A).c: | see CsoA) c), since Yoshida discloses | (C) |
| | by means of | |
| | FIG. 3 and col. 5: 22-26 that it | |
| | comprises in a change always all | |
| | communications connections and | |
| | their data transfers - implemented | |
| | by means of a virtual circuit - and | |
| | moreover | |
| | Col. 5: 27-64 that its change cannot | |
| | take place during the connection | |
| | establishment until its CONTROL | |
| | CHANNEL PROCESSOR 27 has | |
| | received a “connection | |
| | acknowledgement signal”. | |
| A.2).d contradicts A).d: | Yoshida excludes any non-IP | (C) |
| | telephone connectability | |
| A.2).e contradicts A).e: | see CoA.2).e | (C) |
| A.2).f contradicts A).f: | see CsoA).f | (C) |
| B.2).a contradicts B).a: | see CsoB).a | (C) |
| C.2).a contradicts C).a: | see CsoC).a | (C) |
| C.2).b contradicts C).b: | see CsoC).b | (C) |
| C.2).c contradicts C).c: | see CsoC).c | (N) |
| C.2).d contradicts C).d: | see CsoC).d | (C) |
| C.2).e contradicts C).e: | see CsoC).e | (C) |
| D.2).a not-discloses D).a: | see CsoD).a, since the change signal | (N) |
| | is only triggered by the CHANNEL | |
| | CHANGER 29, thus automatically by | |
| | an unknown reason, col. 6: 61-66 | |
| D.2).b not-discloses D).b: | see CsoD).b, since as in CSoD.2).a | (N) |
| D.2).c contradicts D).c: | see CsoD).c. | (C) |

### II.C.3 LUCENT—Document.3/NK22

The following 14 “not-discloses”/“contradicts” relations result from document.3 disclosures:

| | | |
|---|---|---|
| A.3).a not-discloses A).a: | see CsoA).a | (N) |
| A.3).b not-discloses A).b: | see CsoA).b | (N) |
| A.3).c contradicts A).c: | see CsoA).c | (C) |
| A.3).d not-discloses A).d: | see CsoA).d | (N) |
| A.3).e contradicts A).e: | see CsoA).d | (C) |
| A.3).f not-discloses A).f: | see CsoA).f | (N) |
| C.3).a contradicts C).a: | see CsoC).a | (C) |
| C.3).b not-discloses C).b: | see CsoC).b | (N) |
| C.3).c contradicts C).c: | see CsoC).c | (C) |
| C.3).d contradicts C).d: | see CsoC).d | (C) |
| C.3).e not-discloses C).e: | see CsoC).e | (N) |
| D.3).a contradicts D).a: | see CsoD).a | (C) |
| D.3).b not-discloses D).b: | see CsoD).b | (N) |
| D.3).c contradicts D).c: | see CsoD).c | (C) |

### II.C.4 TADAMURA—Document.4/NK23

Document.4 is content wise identical to document.7/NK37, analysed in Section 11.0.7.

### II.C.5 MATUSKAWA—Document.5/NK24a

Matuskawa discloses an “ISDN terminal adapter 1” (e.g. FIG. 1 or claim 1), which automatically switches a “data communication” of the “transmitting DTE 2” from packet-switching to line-switching mode, according to the results of its “timer 14”, (e.g. col. 1:<claim 1> or col. 2:<0013> or col. 3:<0018>, 2^{nd} sentence) stating “no reply” and “data delayed” with the packet-switching data transfer. Note that timer 14 according to col. 3:<0019> measures the time of the layer-3-data packets DTE-to-DTE delivery confirmation. Such packets are definitively not the '884 end-terminal-to-end-terminal packets of the '884 communications connection considered and therefore do not belong to the '884 data transfer. While they do may generate a “switching request” signal if a predetermined time is exceeded (ABSTRACT), this signal has nothing to do with an '884 signal. In addition: Its single network is an ISDN.

From the document.5 disclosures result 14 “not-discloses”/“contradicts” relations.

| | | |
|---|---|---|
| A.5).a not-discloses A).a: | see CsoA).a no communications | (N) |
| | connection/2^{nd} switch | |
| A.5).b not-discloses A).b: | see CsoA).b, since M does not | (N) |
| | observe the local forwarding of packets | |
| A.5).c not-discloses A).c: | see CsoA).c, since M can only | (N) |
| | change with the expiry of its timer 14 | |
| A.5).d not-discloses A).d: | see CsoA).d | (N) |
| A.5).e contradicts A).e: | see CsoA).e (see footnote 19) | (C) |
| A.5).f contradicts A).f: | see CsoA).f | (C) |
| B.5).a contradicts B).a: | see CsoB).a | (C) |
| C.5).a contradicts C).a: | see CsoC).a | (C) |
| C.5).b contradicts C).b: | see CsoC).b | (C) |
| C.5).c not-discloses C).c: | see CsoC).c | (N) |
| C.5).d contradicts C).d: | see CsoC).d | (C) |
| D.5).a contradicts D).a: | see CsoD).a | (C) |
| D.5).b not-discloses D).b: | see CsoD).b | (N) |
| D.5).c not-discloses D).c: | see CsoD).c | (N) |

### II.C.6 KIMURA—Document.6/NK25a

Kimura discloses a “line*packet selection communication system” consisting of a “network control device 18” or “mesh control device 18” and “line terminating device 19” on the one side of a “subscriber's line 21” and on the other side of it a “communication mode switching device 20” (FIG. 3 and its description on page 281/282: bottom/top). Both these sides' units jointly switch the “mode to communicate” of a terminal 17 from packet-switching to line-switching service, by means of a corresponding request by the terminal or the “exchanger” (=one of the line-/packet-switching devices in the network, 13 or 14) being a “control signal” on 21—wherein 21 is the sole “subscriber's line” on which both network services are accessible (but not the networks as such providing these services). They execute this switch-over of 21 “per call or during call, according to communication form (conversational form or file transmission form, etc), quantity of information for communication, and/or the other <party> of the communication, sharing the subscriber's line terminating device.”, page 281 last paragraph and page 286 first paragraph, whereby the term “during calf” has a very specific meaning, as explained next.

Throughout a “calf” real-time data transfer guarantee is neither required nor disclosed by Kimura—only the possibility of switching-over the “communication mode” of the terminal if its “communication form” changes. This is confirmed by the last/first lines on pages 285/286 in detail: that namely Kimura's change-over solely “ . . . has the effect of the user economically materializing the most suitable communication method according to the communication form (conversational form or file transmission form), quantity of information communicated and the other party of the communication, sharing the subscriber's line terminating device.”—with which he explicitly rules out that he executes his change during the “conversational communication form”, which is permanently maintained throughout the whole duration of a telephone call and in which all its data transfer takes place. I.e.: Kimura has not designed his change over for guaranteeing the real-time data transfer quality throughout a call, and it indeed cannot guarantee it.

I.e.: By means of Kimura's change over it is impossible to guarantee the real-time data transfer quality throughout a call, as there is no way of instantly reacting to a threatening and/or actual loss of this quality, e.g. due to fluctuations of service quality of the packet-switched network or detection of the non-availability of some resource within his devices 18/19 required for using the packet-switched network to this end.

Finally, Kimura not discloses/claims that switching-over 21 “during call”—whiles the communications form is not changed, as is the case in a telephone call—the current call can be continued. Rather in the only disclosures referring to switching over “during call”, in Case 3, absolutely nothing alike is disclosed. Instead, as in Case 1 and Case 2, Kimura assumes also here that the “incoming call” from line-switcher 13 considered in Case 3 (see page 284, right column, last paragraph) is an independent call (as the former call's “communications form” is not changed, if it is a telephone call, as in the '884 case), on detection of which—unless its acceptance is refused by the called terminal 17 (page 285, left column, first paragraph)—the ongoing “communication by packet exchange mode is ended” (see also page 285, left column, lower part, i.e. the '884 telephone call). I.e.: while the Kimura switching-over of 21 may occur also during an ongoing packet-switched call over it, this would be disrupted if it is due to a non-refused incoming call from line-switcher 13.

This corresponds precisely to the technical problem (economically important at that time), which Kimura wants to solve and explains in detail on page 281/282 last/first paragraphs: namely to offer on only a single subscriber line 21 to a user at terminal 17 at any time access to both the line- and packet-switching functionalities of networks. But this Kimura solution by far does not guarantee a real time data transfer in a telephone call over an arbitrary packet-switching network (e.g. the Internet) and line-switching, not to speak of providing access to two such separate networks. Kimura therefore nowhere claims its solution were suitable for guaranteeing real-time data transfers as required for telephone calls over any packet-switching network, if only also an ISDSN/PSTN were accessible—but rules this out quite explicitly (see above) at the aforementioned references.

Kimura has accordingly nothing to do with the '884 change of a data transfer between two separate network accesses—quite the contrary: his sole aim is to replace these separate network accesses by a single access to both their services.

From the document.6 disclosures follow 12 “not-discloses”/contradicts” relations:

| | | |
|---|---|---|
| A.6).a contradicts A).a: | see CsoA).a, since K's system lies on | (C) |
| | both ends of the subscriber line 21 | |
| A.6).b contradicts A).b: | see CsoA).b, as K rules out real-time | (C) |
| | reaction, see above | |
| A.6).c contradicts A).c: | see CsoA6).c, as in CsoA).b | (C) |
| A.6).d not-discloses A).d: | see CsoA).d | (N) |
| A.6).e not-discloses A).e: | see CsoA).e | (N) |
| A.6).f contradicts A).f: | see CsoA).f, see above | (C) |
| C.6).b not-discloses C).b: | see CsoC).b | (N) |
| C.6).c not-discloses C).c: | see CsoC).c | (N) |
| C.6).e contradicts C).e: | see CsoC).e, see page 3, right col. 2, | (C) |
| | 2^{nd} para. | |
| D.6).a contradicts D).a: | see CsoD).a, since K's signals do not | (C) |
| | have all 3 alternative causes | |
| D.6).b contradicts D).b: | see CsoD).b, as K's signals can be | (C) |
| | refused sometimes, see above | |
| D.6).c contradicts D).c: | see CsoD).c, as K's signals sometimes | (C) |
| | need acknowledgement, see above | |

### II.C.7 TAXI System—Document.7/K2

The technical document.7 is equal to document.8/K3, see the next Section.

### II.C.8 IDB-64/2.i—Document.8/K3

The document.8 discloses an IDB (=ISDN dial backup) system, which has access to an ISDN and thus can substitute network connections via modem-driven leased lines—in the event of the latters' breakdown—but does not consider, at all, substituting network connections via a packet-switching network, the use of which is based on techniques being dramatically different from those for using leased lines and modems. The establishment of a substituting network connection over the ISDN for the '884 communications connection by the IDB system is ruled out also by several other technical reasons. For example: The IDB system definitively is not capable of changing-over only a single telephone call or communications connection (as it does not even know this notion indispensably required by the '884 invention), and its establishing of its ISDN bypass of its modem-driven leased lines lasts 1-4 seconds (destroying the needed real-time quality of an ongoing telephone call or communications connection).

From the document.8 disclosures follow the 15 “not-discloses”/“contradicts” relations:

| | | |
|---|---|---|
| A.8).a contradicts A).a: | see CsoA).a, since packet switching | (C) |
| | data transfer ruled out | |
| A.8).b contradicts A).b: | see CsoA).b, see above. | (C) |
| A.8).c contradicts A).c: | see CsoA).c, see above | (C) |
| A.8).d contradicts A).d: | see CsoA).d | (C) |
| A.8).e contradicts A).e: | see CsoA).e | (C) |
| A.8).f contradicts A).f: | see CsoA).f, see above | (C) |
| B.8).a contradicts B).a: | see CsoB).a | (C) |
| C.8).a contradicts C).a: | see CsoC).a | (C) |
| C.8).b contradicts C).b: | see CsoC).b | (C) |
| C.8).c contradicts C).c: | see CsoC).c | (C) |
| C.8).d contradicts C).d: | see CsoC).d | (C) |
| C.8).e contradicts C).e: | see CsoC).e | (C) |
| D.8).a contradicts D).a: | see CsoD).a | (C) |
| D.8).b contradicts D).b: | see CsoD).b | (C) |
| D.8).c contradicts D).c: | see CsoD).c | (C) |

### II.C.9 MALEK—Document.9/K8

Document.9 discloses only a number of aspects of service-integration in communications networks (always to be achieved within these networks). The quite different idea of an integrated use of separate accesses to a packet- and a line switching network (not needing any support by these networks)—insofar being technically and organisationally dramatically different to the integrated use of packet- and line switching network services at a single network access—is not even mentioned by it, in particular not in a single communications connection. I.e., Malek clearly excludes the '884 switch with its separate access to each of these two types of separate networks.

From the document.9 disclosures follow 15 “not-discloses “/” contradicts” relations:

| | | |
|---|---|---|
| A.9).a contradicts A).a: | see CsoA.9).a, since a network external | (C) |
| | switch is ruled out | |
| A.9).b contradicts A).b: | see CsoA.9).b, see above | (C) |
| A.9).c contradicts A).c: | see CsoA.9).c | (C) |
| A.9).d contradicts A).d: | see CsoA.9).d | (C) |
| A.9).e contradicts A).e: | see CsoA.9).e | (C) |
| A.9).f contradicts A).f: | see CsoA.9).f | (C) |
| B.9).a contradicts B).a: | see CsoB.9.a | (C) |
| C.9).a contradicts C).a: | see CsoC.9.a | (C) |
| C.9).b contradicts C).b: | see CsoC.9).b | (C) |
| C.9).c contradicts C).c: | see CsoC.9).c | (C) |
| C.9).d contradicts C).d: | see CsoC.9).d | (C) |
| C.9).e contradicts C).e: | see CsoC.9).e | (C) |
| D.9).a contradicts D).a: | see CsoD.9).a | (C) |
| D.9).b contradicts D).b: | see CsoD.9).b | (C) |
| D.9).c contradicts D).c: | see CsoD.9).c | (C) |

### II.C.10 WACKER—Document.10/K9

Document 10 also considers, similar to document.8 and its IDB system, the use of network access integrated packet- and line-switching services of internally somehow interconnected networks, while it completely ignores the question of the integrated use of completely separate networks, as they frequently existed at the priority date and still exist today. The primary difference is: Its focus is on supporting direct LAN/LAN-modem-connections in case of their overload or failure or temporary replacement (as they then may be more expensive than ISDN connections), whereby now the IDB system of document.8 is replaced by a system consisting of an IA (=“ISDN adapter”) together with a suitable LAN/LAN router.

The document.10 disclosures imply 15 “not-discloses”/“contradicts” relations:

| | | |
|---|---|---|
| A.10).a contradicts A).a: | see CsoA).a, | (C) |
| A.10).b contradicts A).b: | see CsoA).b | (C) |
| A.10).c contradicts A).c: | see CsoA).c | (C) |
| A.10).d contradicts A).d: | see CsoA).d | (C) |
| A.10).e contradicts A).e: | see CsoA).e | (C) |
| A.10).f contradicts A).f: | see CsoA).f | (C) |
| B.10).a contradicts B).a: | see CsoB).a | (C) |
| C.10).a contradicts C).a: | see CsoC).a | (C) |
| C.10).b contradicts C).b: | see CsoC).b | (C) |
| C.10).c contradicts C).c: | see CsoC).c | (C) |
| C.10).d contradicts C).d: | see CsoC).d | (C) |
| C.10).e contradicts C).e: | see CsoC).e | (C) |
| D.10).a contradicts D).a: | see CsoD).a | (C) |
| D.10).b contradicts D).b: | see CsoD).b | (C) |
| D.10).c contradicts D).c: | see CsoD).c | (C) |

### II.C.11 AVM—Document.11/K11

Document.11 discloses the same technical teaching as document.8 and document.10, except that now the ISDN adapter and router are integrated and that the replacement alias backup circuits for e.g. modem direct connections are in the background and now remote connections are made primarily via the ISDN, whereby the at the time very popular NetWare MultiProtocolRouter was always used (so that practically all then important LAN and WAN protocols could be routed therewith, particularly IPX, TCP/IP, Apple Talk . . . ). These “network interoperability” aspects of data transfers have however nothing to do with their real-time quality (being an indispensable property in telephone calls). Consequently, the connection of a telephone to this AVM router is again technically ruled out, just as the monitoring of the quality of an individual communications connection and performing therein a dynamic change-over with it.

From the document.11 disclosures therefore result (as with document.8/10) 15 “contradicts” relations

| | | |
|---|---|---|
| A.11).a contradicts A).a: | see CsoA).a | (C) |
| A.11).b contradicts A).b: | see CsoA).b | (C) |
| A.11).c contradicts A).c: | see CsoA).c | (C) |
| A.11).d contradicts A).d: | see CsoA).d | (C) |
| A.11).e contradicts A).e: | see CsoA).e | (C) |
| A.11).f contradicts A).f: | see CsoA).f | (C) |
| B.11).a contradicts B).a: | see CsoB).a | (C) |
| C.11).a contradicts C).a: | see CsoC).a | (C) |
| C.11).b contradicts C).b: | see CsoC).b | (C) |
| C.11).c contradicts C).c: | see CsoC).c | (C) |
| C.11).d contradicts C).d: | see CsoC).d | (C) |
| C.11).e contradicts C).e: | see CsoC).e | (C) |
| D.11).a contradicts D).a: | see CsoD).a | (C) |
| D.11).b contradicts D).b: | see CsoD).b | (C) |
| D.11).c contradicts D).c: | see CsoD).c | (C) |

### II.C.12 TADAMURA—Document.12/NK37 & Document.4/NK23

These elaborations are based on document.7/NK37, with identical content as document.4/NK23.

Tadamura's technique teaching is based on a COMMUNICATION CONTROL APPARATUS 200, a special “ISDN terminal adapter” (FIGS. 2 and 26), which switches a data communication over an ISDN from packet to line switching mode or vice versa, if the actual mode is proving inadequate, col. 1:11-44. From the description of the technical problem to be solved by it—by means of its target guidelines 1-4 in col. 2:24-62—and the description of the associated solution alias technique teaching according to the invention in col. 2:63-4:68, it is evident that he has designed his change-over not for the purpose of ensuring the real-time quality of a data transfer, e.g. to make it suitable for Internet telephony. Rather all these 4 problem descriptions and the solution provided by Tadamura—inter alia with its exclusion of change-over decisions by the network management, as is absolutely indispensable to this end—disclose that his technical solution explicitly excludes the real-time guarantee of its data transfer. In addition: It knows only a single network, namely an ISDN.

From the document.12 disclosures result 15 “not-discloses”/“contradicts” relations:

| | | |
|---|---|---|
| A.12).a contradicts A).a: | see CsoA).a, since T. knows no ′884 | (C) |
| | signal | |
| A.12).b contradicts A).b: | see CsoA).b, since T. excludes real-time | (C) |
| | data transfer, see above. | |
| A.12).c contradicts A).c: | see CsoA).c, in T. a connection cannot | (C) |
| | trigger a change | |
| A.12).d not-discloses A).d: | see CsoA).d | (N) |
| A.12).e contradicts A).e: | see CsoA).e (see footnote 12) | (C) |
| A.12).f contradicts A).f: | see CsoA).f, see above | (C) |
| B.12).a contradicts B).a: | see CsoB).a | (C) |
| C.12).a contradicts C).a: | see CsoC).a | (C) |
| C.12).b contradicts C).b: | see CsoC).b | (C) |
| C.12).c not-discloses C).c: | see CsoC).c | (N) |
| C.12).d contradicts C).d: | see CsoC).d | (C) |
| C.12).e contradicts C).e: | see CsoC).e | (C) |
| D.12).a contradicts D).a: | see CsoD).a | (C) |
| D.12).b contradicts D).b: | see CsoD).b | (C) |
| D.12).c contradicts D).c: | see CsoD).c | (C) |

### II.C.13 LEE—Document.13/NK38

Lee's technique teaching puts in practice a “dynamic connection management in integrated communication networks”, Abstract and FIG. 9—more precisely: in a single “connection-orientated integrated communication network”, col. 1:15-18, 2:52-54, not being ruled out by further developed future ISDNs, but today not yet realisable—which maintains for the duration of a “connection” its acceptable QOS (=quality of service). All its claims are actually pure method claims worded such that they know no switches at all, neither inside nor outside of this network. It recognises at this network only two end users and an information transfer between them, col. 1:15-18. I.e.: It even does not disclose how these two users interact with this single communications network, but excludes that they each use 2 network accesses for this.

It states in a beautifully philosophical—but absolutely not-enabling—manner that the information transfer between them is achieved by means of network functions, which select network operating means for same and allocate these along a suitable path for same. The logical association between the communication end users he names “call”, the chain of network operating means supporting it at any time—along the above path—he names “connection” and by “connection management he means the network function which sets up, maintains and tears down connections”, col. 1:18-27. He supports a call taking place at various times through different connections.

From the document.13 disclosures result 15 “not-discloses”/“contradicts” relations:

| | | |
|---|---|---|
| A.13).a contradicts t A).a: | see CsoA).a, as Lee (= L) knows no | (C) |
| | switch | |
| A.13).b contradicts A).b: | see CsoA).b, as above | (C) |
| A.13).c contradicts A).c: | see CsoA).c, as above | (C) |
| A.13).d contradicts A).d: | see CsoA).d, as above | (C) |
| A.13).e contradicts A).e: | see CsoA).e, as above | (C) |
| A.13).f contradicts A).f: | see CsoA).f, as above | (C) |
| B.13).a not-discloses B).a: | see CsoB).a | (N) |
| C.13).a contradicts C).a: | see CsoC).a, as L recognises no | (C) |
| | line-switching connection | |
| C.13).b not-discloses C).b: | see CsoC).b, as L discloses nothing on | (N) |
| | this | |
| C.13).c not-discloses C).c: | see CsoC).c, as L discloses nothing on | (N) |
| | this | |
| C.13).d contradicts C).d: | see CsoC).d | (C) |
| C.13).e contradicts C).e: | see CsoC).e | (C) |
| D.13).a contradicts D).a: | see CsoD).a, as L knows no switch | (C) |
| D.13).b contradicts D).b: | see CsoD).b, as L knows no switch | (C) |
| D.13).c contradicts D).c: | see CsoD).c, as L knows no switch | (C) |

### II.C.14 NOGUCHI—Document.14/NK40

Noguchi's technique teaching is focussed on the functional design of a “distributed processing ISDN switch” (see ABSTRACT or col. 3/4:44/12). The patent outlines the latter's structure, as to the invention, consisting of the switch-internal bus system functional units (60/61/62), and the functional units (10, 11) on the terminal side connected thereto, and the processing/exchanging/transferring side functional units (30, 40, 50) of the “voice/data” information coming in/going out from/to the DTEs, as well as the interactions of these groups of functional units. It thus has absolutely nothing to do with its use in a data transfer from one to another such distributed-operating ISDN switch and/or switching-over of this data transfer from the use of a packet switching network to the use of a line switching network, and therefore cannot address real-time quality features of thus (not existing) data transfers.

From the document.14 disclosures result 15 “not-discloses”/contradicts“relations:

| | | |
|---|---|---|
| A.14).a contradicts A).a: | see CsoA.14).a, as Noguchi discloses | (C) |
| | no PSN | |
| A.14).b contradicts A).b: | see CsoA.14).b, as N. rules out a PSN | (C) |
| A.14).c contradicts A).c: | see CsoA.14).c, as above | (C) |
| A.14).e contradicts A).e: | see CsoA.14).e, as above | (C) |
| A.14).f contradicts A).f: | see CsoA.14).f, as above | (C) |
| B.14).a not-discloses B).a: | see CsoB.14).a as above | (C) |
| C.14).a contradicts C.a.: | see CsoC.14).a as above | (C) |
| C.14).b not-discloses C).b: | see CsoC.14).b, as above | (N) |
| C.14).c not-discloses C).c: | see CsoC.14).c, as N discloses nothing | (N) |
| | on this | |
| C.14).d contradicts C).d: | see CsoC.14).d, as N rules out a PSN | (C) |
| C.14).e contradicts C).e: | see CsoC.14).e, as above | (C) |
| D.14).a contradicts D).a: | see CsoD.14).a, as N excludes a | (C) |
| | network management | |
| D.14).b contradicts D).b: | see CsoD.14).b, as N rules out a “′884” | (C) |
| | trigger | |
| D.14).c contradicts D).c: | see CsoD.14).c, as N rules out a PSN | (C) |

### II.C.15 ARCHIBALD—Document.15/NK41

Archibald's technique teaching is based on a “data communications network” which uses a “leased line” 102, as “primary communications channel” and a “dial-up line” 101 of a “telephone network” 200 as “backup/secondary communications channel” between two modems 100 and 300, which in turn are connected to the two DTEs 50 and 450. When one of the two modems encounters a reduction of the “signal quality” on the rented line it automatically sets-up a dial line “data connection”.

From the document.15 disclosures result 15 “not-discloses”/“contradicts” relations:

| | | |
|---|---|---|
| A.15).a contradicts A).a: | see CsoA).a, as Archibald rules out a | (C) |
| | packet switching network | |
| A.15).b contradicts A).b: | see CsoA).b, as above | (C) |
| A.15).c contradicts A).c: | see CsoA).c, as above | (C) |
| A.15).d contradicts A).d: | see CsoA).d, as Archibald rules out | (C) |
| | connection of a telephone | |
| A.15).e contradicts A).e: | see CsoA).e, as Archibald rules out a | (C) |
| | packet switching network | |
| A.15).f contradicts A).f: | see CsoA).f, as above | (C) |
| B.15).a contradicts B).a: | see CsoB).a, as above | (C) |
| C.15).a contradicts C).a: | see CsoC).a, as above | (C) |
| C.15).b contradicts C).b: | see CsoC).b, as above | (C) |
| C.15).c not-discloses C).c: | see CsoC).c, as A discloses nothing on | (N) |
| | this | |
| C.15).d contradicts C).d: | see CsoC).d, as Archibald rules out a | (C) |
| | packet switching network | |
| C.15).e contradicts C).e: | see CsoC).e, as A. rules out a packet | (C) |
| | switching network | |
| D.15).a contradicts D).a: | see CsoD).a, as A rules out a network | (C) |
| | management for this | |
| D.15).b contradicts D).b: | see CsoD).b, as A rules out an “′884” | (C) |
| | trigger for this | |
| D.15).c not-discloses D).c: | see CsoD).c, as A has first to determine | (N) |
| | an “error rate” | |

### II.C.16 VAZVAN—Document.16/S1

Vazvan's technique teaching deals with an integrated system of mobile terrestrial as well as satellite networks, which he calls MUMTS (=multimode universal mobile telecommunications system), connected also to fixed line networks (31, 33, 34, 44), which is used by so-called MMTs/DMTs (=multimode/dual mode terminals) terminals (43). While moving, a terminal of this kind may establish one “connection”—more precisely: one “data link”—after another to several networks, one at a time, by requesting access to the respective network and, after have received same, use the various services of the then “network connected”. An MMT/DMT may forward its connection (i.e. data link), as it moves from one network to another one between these, by “handover” alias “hand-off”, more precisely by “access (requested/granted) handover alias hand-off”. The handover decision for it always is based also on the quality of the connection—while an '884 change-over signal often ignores quality.

Note that VAZVAN's “connection” (being a “data link” in internationally standardised telecommunications experts' language) is not the '884 end-terminal-to-end-terminal “communications connection” of a telephone call, as disclosed in the '884 specification. I.e.: In VAZVAN's patent
i) A “connection” is to be understood as the data link between on the one hand DMT/MMT and on the other hand MSC (terrestrial) or satellite earth station (non-terrestrial)—see e.g. page 7:33, 8:36, 9:4, 11:10 12:5-6, 13:11-12, 21:4, 21:35, 22:2, 22:15, 24:14, 24:20, 24:37, 25:3, 25:28, 25:33.
ii) A “connection” allows the user of a DMT/MMT “real-time access” (page 8:34) to a network in the MUMTS, more precisely: to its MSC (terrestrial network) or its satellite earth station (non-terrestrial network). It realises the connectivity of a DMT/MMT with the MUMTS, but not an end-terminal-to-end-terminal communications connection—though this access connection is necessary for the technical realization of the latter.
iii) A “connection” between a DMT/MMT and its current network is replaced, in an “access handover” by a new “connection” between this DMT/MMT and the new MSC respectively new satellite earth station (page 6:8, 6:16-16, 9:1-6, 13:11-12, 20:9). The DMT/MMT does not therefore permanently have access, as in the '884 case, to a network necessary for its data transmission, but must instead request this access each time before entering such a network (page 9:4-6) and thereby leave its current network, because it may only belong to a single network at any time (apart from handover periods), namely to the network whose VLR it contains (page 20:1-6, 20:9-11).
iv) A “connection” of the DMT/MMT in a new network exists only after its MSC or satellite earth station has granted it access, i.e. it has “accepted” the handover (page 7:2 for the former, 7:4 for the latter). The DMT/MMT cannot at anytime use the line-switching network for establishing a line-switched connection to the second switch—which is not even disclosed by VAZVAN (because not needed in it).
v) “Access requests” to a network are alien to the '884 patent, where (see e.g. the lines 8 and 9 in its FIG. 1) the access to both networks is permanently available to both switches.
vi) A “call” could in principle stand for a) an end-terminal-to-end-terminal data transmission, and/or b) of the '884 communications connections of a telephone call, and/or which c) permanently uses the same two switches—but VAZVAN does not disclose any of these 3 features, but refers exclusively to “data calls”²¹⁾. ²¹ VAZVAN does not mention a telephone call anywhere. He does indeed mention: telephones as MMTs/DMTs and thereby also discloses the additional technical conditions necessary for them (“fixed networks”, page 9:29, or “data terminal equipment” separate from “radio unit”, page 13:4-5). It does not, however, disclose in a single word that these would meet both the fundamental technical requirements set by: Data processing data transmission technology (main feature: no remaining bit errors or packet losses whatsoever and thus, if appropriate, data transmission section based data transmission repetition, thus excluding meeting the telephony real-time requirement) such that it is suitable also for Telephone call data transmission technology (main feature: signal delay <0.5 sec, therefore often no data transmission repetition whatsoever but instead, as appropriate, acceptance of remaining bit errors and/or packet losses, i.e. unconditionally meeting telephony real-time requirement—being diametrically opposite to the then established data transmission requirement, as described in the preceding bullet point). In other words: Solely the mention of the possibility of also involving a telephone in the realisation of an MMT/DMT—VAZVAN nowhere refers to any more than this—is not a disclosure of having this telephone integrated into the two above and diverging data transmission technologies in a way such that this facilitates an '884 real-time data transmission. “calls terminated in a mobile station” and “calls originating in a mobile station”, page 19:20 and 33, but he does not disclose anywhere with a single word that these calls could be telephone calls. Instead the only universally disclosed interpretation of these calls is that they are “data calls” (e.g. page 12 at several points or page 13:4-5 “data terminal equipment”), and this corresponds to the situation of interest at the time and its feasibility expectation. In other words: the mere mention of the word “call” as such is not a disclosure of any kind that it may comprise “telephone call”, with its considerably different telephony data transmission technology as compared to (see the preceding bullet point) the data processing data transmission technology solely referred to everywhere else by VAZVAN. Conclusion: VAZVAN does not claim his change-over to a line-switching network works in any telephone call via an arbitrary packet-switching network (as is the case with the '884 change-over)—and it actually does not (intend to) work this way, as shown e.g. in vii) and viii).
vii) For a “call”, VAZVAN does not disclose either that its data transmission—realised over a packet-switching network—is guaranteed to be of real-time quality by instantly changing to a line-switching network as soon as the latter is challenged, as this network simply need not be available anytime, while in the '884 case it is.
viii) VAZVAN does maintain that a “call would not be interrupted” by his handover of a “connection” during a call using it (page 19/20)—but he discloses absolutely nothing enabling how he would achieve this (as this was definitively not part of ordinary skill at his priority date, just as it is today).
ix) VAZVAN explicitly discloses that his handover of a “connection” between two networks of his MUMTS requires elaborate cooperation and information exchanges between these networks for achieving it (see the description of FIG. 1 (page 6:19-page 7:20)—while the '884 change-over requires no such cooperation and/or information exchanges between the involved packet-switched and line-switched networks (which both even don't know about an '884 change-over taking place between them.
x) VAZVAN explicitly discloses that his handover decision of a “connection” is always based also on the quality of the connection—while in many cases the '884 change-over signal requires no such consideration.

The aforementioned differences i)-x) show that VAZVAN and the '884 patent deal with totally different telecommunications configurations, totally different problems and hence totally different solutions.

Vazvan's technique teaching is restricted per se to mobile networks and mobile terminals. Since its description at one point (page 9:29-31) is however vague and speaks also of fixed networks/telephone terminals, the preceding paragraph also allows the corresponding generalisation—but this has no effect on the following relational facts.

From the document.16 disclosures result 15 “not-discloses”/“contradicts” relations:

| | | |
|---|---|---|
| A.16).a contradicts A).a: | see CsoA).a, since Vazvan rules out an | (C) |
| | ′884-signal | |
| A.16).b contradicts A).b: | see CsoA).b, since V rules out that the | (N) |
| | terminal itself triggers a signal | |
| A.16).c not-discloses A).c: | see CsoA).c, since V discloses no | (N) |
| | packet switching network | |
| A.16). d not-discloses A).d: | see CsoA).d, since V discloses no | (N) |
| | telephone calls | |
| A.16).e contradicts A).e: | see CsoA).e, since V rules out the | (C) |
| | terminal always has PSN access | |
| A.16).f not-discloses A).f: | see CsoA).f, since V discloses no access | (N) |
| | to a PSN | |
| B.16).a not-discloses B).a: | see CsoB).a, since V discloses no | (N) |
| | packet switching network | |
| C.16).a contradicts C).a: | see CsoC).a, since V rules out the | (C) |
| | terminal having constant LSN access | |
| C.16).b not-discloses C).b: | see CsoC).b, since V speaks only of | (N) |
| | data network | |
| C.16).c not-discloses C).c: | see CsoC).c, since V discloses nothing | (N) |
| | on this | |
| C.16).d contradicts C).d: | see CsoC).d, since V rules out the | (C) |
| | terminal having constant PSN access | |
| C.16).e contradicts C).e: | see CsoC).e, since V rules out the | (C) |
| | terminal having constant LSN access | |
| D.16).a contradicts D).a: | see CsoD).a, since V rules out a | (C) |
| | network management signal | |
| D.16).b contradicts t D).b: | see CsoD).b, since V rules out a | (C) |
| | “footnote 13” signal | |
| D.16).c contradicts D).c: | see CsoD).c, since V rules out a “user | (C) |
| | transparent” signal | |

### III. FUTURE ELABORATIONS ON THE FSTP

Finally, what follows hints at a range of preceding disclosures of the FSTP to be used in future claims:
Two different analyses of a PTR may be put as a TT.p and a TT.i and then compared to each other by the FSTP—be it within a single or between two different patent law systems. The same applies to comparing national patent systems to each other and/or the precedents of their courts and/or to their one or several cases.
cMs' may be translated back into the respective disclosures—of interest particularly during inventing a TT.p.
The notions of “orthogonal/independent element attributes”, “orthogonal concepts”, and “independence of thoughts/cMs/concepts” may be limited further significantly—as well as the notion of “non sub-patent-law cM”.
Technical secondary facts confirmation support—in order to make them “average skill attacks” resistant—may be gained by putting limitations on such skill, which it must meet unless it is without any or partial effect. This applies in particular to the equivalence problem.
The need of specific “FSTP-HW” support—be it by ASICs (“application specific integrated chips”) or these integrating SKBCs (“specific knowledge base controllers”)—is disclosed by the current claims wordings, which emphasize that most of their huge number of steps of their exhaustive search algorithms need not be executed sequentially, thus allowing their by several orders of magnitude more efficient “parallel executions” than by ordinary CPUs.
Using the FSTP outside of the patent area for determining a venture's (i.e. its innovation's) semantic height over the pertinent prior knowledge allows and requires a whole series of additional limitations, e.g. as to their existing laws/conventions/regulations and this innovation being subject to or eligible for applying one of these.

What is claimed is:

1) A method—the “FSTP method”—for automatically repeatedly reading/writing information in some predetermined presentations from/to at least one device storing it,
a. whereby this information is at least one item of at least one domain ontology and/or of at least one PTR,
whereby the former item describes at least one detail of at least one
NPS domain ontology and/or
SAOP domain ontology and/or
TT.p-ADMIN domain ontology and/or
another optional domain ontology,
whereby the latter item consists of at least one
element of its TT.p (referred to by “X”, A≦X≦Z) and/or
element of its document.i (referred to by “X.i”, i=1, 2, 3 . . . ,) peer to X and/or
element attribute X).n resp. X.i).n, n=a,b,c, . . . , and/or
concept C of its universe resp. concept value of its concept space, and a
sufficiently large Q0, for terminating the below search,
b. whereby the method also provides
predetermining at least one of the above presentations, and
selecting at least one PTR and its context consisting of at least one above ontology, and
screening this PTR and its context, thus enabling the
transformation of this PTR, based on its context, into this PTR's technical secondary structured fact, whereby this transformation is achieved by an exhaustive search for all solutions of the finite problem of finding, for this PTR and its context, this fact's two components:
1.) the minimal value of q≦Q0,
q=Sum of all p^{X.i).n} and 0≦q≦Q0,
with the p^{X.i).n}'s being determined such that for each X).n there is exactly one peer X.i).n in this sum and for it at least one p^{X.i).n}-cM—these X.i).n's being a q-anticipation-combination—with
“X.i).n/mod(p^{X.i).n}-cM) discloses X).n”,
and
2.) the set of all achievement pairs <q-anticipation-combination, set of all of p^{X.i).n}-cMs of it>, and the
identification of at least one relation between an item of this fact and at least one item of this selected context and/or this selected PTR and/or this fact's derivation, accompanied by natural language information about why this relation exists, whereby this relation is a logic and/or combination of discloses, is disclosed, contradicts, is contradicted relations as well as of their negations, and
integrating this fact and at least one such relation into the information built up in a . . . .

2) A method according to claim 1, wherein the transformation is subject to the additional limitation that in any q-anticipation-combination holds for each X.i: “X.i).n/mod(p^{X.i).n}-cM) discloses X).n for all n.

3) A method according to claim 1, wherein the transformation is subject to the additional limitation that in any document.i, of which at least one X.i).n belongs to a q-anticipation-combination, for all the other X.i).n's holds: “X.i).n not-contradicts X).n”.

4) A method according to claim 1, wherein the transformation is subject to the additional limitation that in any document.i, of which at least one X.i).n belongs to a q-anticipation-combination, the latter's modification by p^{X.i).n}-cM generates a contradiction neither within document.i (i.e. “X.i).n/mod (p^{X.i).n}-cM) contradicts X.i).n” for some other X.i).n) nor with the TT.p (i.e. “X.i).n/mod(p^{X.i).n}-cM) contradicts X).n” for some X.i).n).

5) A method according to claim 1, wherein the transformation is subject to the additional limitation that in 1) neither a whole anticipation-combination nor an attribute X.i).n/mod(p^{X.i).n}-cM) must be considered if it belongs to some given “exception set”, whereby the latter may contain any anticipation-combination over RS and any X.i).n/mod(r-cM), r-cM being some number of r≧0 of some cMs of X.i).n.

6) A method according to claim 1, being subject to the limitation that at least one of its steps within the screening or transformation or identification or integration is achieved automatically by the FSTP.

7) An apparatus—the “FSTP”—for automatically repeatedly reading/writing information in some predetermined presentations from/to at least one means of storing it,
b. whereby this information is an item of at least one domain ontology and/or of at least one PTR,
whereby the former item describes at least one detail of at least one
NPS domain ontology and/or
SAOP domain ontology and/or
TT.p-ADMIN domain ontology and/or
another optional domain ontology,
whereby the latter item consists of at least one
element of its TT.p (referred to by “X”, A≦X≦Z) and/or
element of its document.i (referred to by “X.i”, i=1, 2, 3 . . . ,) peer to X and/or
element attribute X).n resp. X.i).n, n=a,b,c, . . . , and/or
concept C of its universe resp. concept value of its concept space, and a
sufficiently large Q0, for terminating the below search,
c. whereby the apparatus also provides
means for predetermining at least one of the above presentations, and
means for selecting at least one PTR and its context consisting of at least one above ontology, and
means for screening this PTR and its context, enabling the
transformation of this PTR, based on its context, into this PTR's technical secondary structured fact, whereby this transformation is achieved by an exhaustive search for all solutions of the finite problem of finding, for this PTR and its context, this fact's two components:
1.) the minimal value of 0≦q≦Q0,
q=Sum of all p^{X.i).n} and 0≦q≦Q0,
with the p^{X.i).n}'s being determined such that for each X).n there is exactly one peer X.i).n in this sum and for it at least one p^{X.i).n}-cM—these X.i).n's being a q-anticipation-combination—with
“X.i).n/mod(p^{X.i).n}-cM) discloses X).n”,
and
2.) the set of all achievement pairs <q-anticipation-combination, set of all of p^{X.i).n}-cMs of it>, and the
identification of at least one relation between an item of this fact and at least one item of this selected context and/or this selected PTR and/or this fact's derivation, accompanied by natural language information about why this relation exists, whereby this relation is a logic and/or combination of discloses, is disclosed, contradicts, is contradicted relations as well as of their negations, and
means for integrating this fact and at least one such relation into the information built up in a . . . .

8) An apparatus according to claim 7, wherein the transformation is subject to the additional limitation that in any q-anticipation-combination holds for each X.i: “X.i).n/mod(p^{X.i).n}-cM) discloses X).n for all n.

9) An apparatus according to claim 7, wherein the transformation is subject to the additional limitation that in any document.i, of which at least one X.i).n belongs to a q-anticipation-combination, for all the other X.i).n's holds: “X.i).n not-contradicts X).n”.

10) An apparatus according to claim 7, wherein the transformation is subject to the additional limitation that in any document.i, of which at least one X.i).n belongs to a q-anticipation-combination, the latter's modification by p^{X.i).n}-cM generates a contradiction neither within document.i (i.e. “X.i).n/mod (p^{X.).n}-cM) contradicts X.i).n” for some other X.i).n) nor with the TT.p (i.e. “X.i).n/mod(p^{X.i).n}-cM) contradicts X).n” for some X.i).n).

11) An apparatus according to claim 7, wherein the transformation is subject to the additional limitation that in 1) neither a whole anticipation-combination nor an attribute X.i).n/mod(p^{X.i).n}-cM) must be considered if it belongs to some given “exception set”, whereby the latter may contain any anticipation-combination over RS and any X.i).n/mod(r-cM), r-cM being some number of r≧0 of some cMs of X.i).n.

12) An apparatus according to claim 7, being subject to the limitation that at least one of its steps within the screening or transformation or identification or integration is achieved automatically by the FSTP.
